(19) United States
(12) Patent Application Publication
(10) Pub. No.: US 2012/0113680 A1
(43) Pub. Date: May 10, 2012

(54) LIGHT GUIDE BODY AND SURFACE LIGHT SOURCE

(75) Inventors: Yutaka NAKAI, Kanagawa-ken (JP); Tsuyoshi HIOKI, Tokyo (JP); Yoshinori HONGUH, Kanagawa-ken (JP); Takeshi MORINO, Kanagawa-ken (JP); Masataka SHIRATSUCHI, Kanagawa-ken (JP)

(73) Assignee: Kabushiki Kaisha Toshiba, Tokyo (JP)

(21) Appl. No.: 13/231,044

(22) Filed: Sep. 13, 2011

(30) Foreign Application Priority Data
Nov. 5, 2010 (JP) 2010-248222

(51) Int. Cl. F21V 8/00

(52) U.S. Cl. 362/611; 362/615

(57) ABSTRACT

According to one embodiment, a light guide body includes a light guide plate and a prism array unit. The light guide plate has a major surface, a first side surface, and a second side surface on an opposite side to the first side surface. The prism array unit is provided on the major surface to be in contact with the major surface. The prism array unit includes a plurality of prism bodies. Each of the prism bodies extends along a first direction from the first side surface to the second side surface. The prism bodies are disposed to align along a second direction parallel to the major surface and perpendicular to the first direction. A vertex angle of the prism bodies is a substantially right angle. A refractive index of the prism bodies is higher than a refractive index of the light guide plate.

### CROSS-REFERENCE TO RELATED APPLICATIONS

This application is based upon and claims the benefit of priority from the prior Japanese Patent Application No. 2010-248222, filed on Nov. 5, 2010; the entire contents of which are incorporated herein by reference.

### FIELD

Embodiments described herein relate generally to a light guide body and a surface light source.

### BACKGROUND

In liquid crystal display devices and the like, for example, a surface light source is provided on the back surface of a liquid crystal panel. The surface light source includes, for example, a light source and a light guide body guiding the light emitted from the light source. Also a configuration is possible in which a plate-like light guide body is combined with a prism array having a refractive index higher than the refractive index of the light guide body.

On the other hand, there is a technology that controls the in-plane luminance distribution of a surface light source based on the display image to improve contrast and reduce power consumption. More specifically, the in-plane distribution of the light emitted from the surface light source is controlled by controlling the quantity of light of each of a plurality of light sources provided at the side surface of a light guide body and entering the light into the light guide body.

In light guide bodies used for such uses, it is notable to control the spread of the light entered and guided with good controllability.

### BRIEF DESCRIPTION OF THE DRAWINGS

FIG. 1A to FIG. 1C are schematic views showing a light guide body according to a first embodiment;

FIG. 2 is a schematic perspective view showing a surface light source according to the first embodiment;

FIG. 3 is a schematic plan view showing the operation of the light guide body and the surface light source according to the first embodiment;

FIG. 4A to FIG. 4C are schematic views showing a light guide body and a surface light source of a reference example;

FIG. 5A and FIG. 5B are schematic diagrams showing the characteristics of the light guide body and the surface light source;

FIG. 6A to FIG. 6C are schematic views showing the characteristics of the light guide body according to the first embodiment;

FIG. 7A and FIG. 7B are schematic perspective views showing light guide bodies and surface light sources of reference examples;

FIG. 8A and FIG. 8B are schematic diagrams showing the characteristics of the light guide body and the surface light source according to the first embodiment;

FIG. 9A and FIG. 9B are graphs showing the characteristics of the light guide body and the surface light source according to the first embodiment;

FIG. 10 is a graph showing the characteristics of the light guide body and the surface light source;

FIG. 11A to FIG. 11E are schematic views showing the light guide bodies according to the first embodiment;

FIG. 12A and FIG. 12B are schematic cross-sectional views showing the configuration and operation of a light guide body according to the first embodiment;

FIG. 13 is a schematic cross-sectional view showing a light guide body according to the first embodiment;

FIG. 14A to FIG. 14F are schematic cross-sectional views showing light guide bodies according to the first embodiment;

FIG. 15A and FIG. 15B are schematic cross-sectional views showing the configuration and operation of a light guide body and a surface light source according to the first embodiment;

FIG. 16 is a schematic cross-sectional view showing the configuration and operation of a light guide body and a surface light source according to the first embodiment;

FIG. 17A and FIG. 17B are schematic cross-sectional views showing the configuration and operation of a light guide body and a surface light source according to the first embodiment;

FIG. 18A to FIG. 18C are schematic views showing a light guide body according to a second embodiment;

FIG. 19 is a schematic view showing a surface light source according to the second embodiment;

FIG. 20 is a schematic view showing the operation of the light guide body and the surface light source according to the second embodiment;

FIG. 21 is a schematic cross-sectional view showing a light guide body according to the second embodiment;

FIG. 22 is a schematic cross-sectional view showing the configuration and operation of a light guide body and a surface light source according to the second embodiment;

FIG. 23A and FIG. 23B are schematic cross-sectional views showing the configuration and operation of a light guide body and a surface light source according to the second embodiment;

FIG. 24 is a schematic cross-sectional view showing the configuration and operation of a light guide body and a surface light source according to the second embodiment;

FIG. 25A to FIG. 25D are schematic views showing light guide bodies and surface light sources according to a third embodiment; and

FIG. 26 is a schematic view showing a light guide body according to a fourth embodiment.

### DETAILED DESCRIPTION

According to one embodiment, a light guide body includes a light guide plate and a first prism array unit. The light guide plate has a first major surface, a first side surface, and a second side surface on an opposite side to the first side surface. The first prism array unit is provided on the first major surface of the light guide plate to be in contact with the first major surface. The first prism array unit includes a plurality of first prism bodies. Each of the plurality of first prism bodies extends along a first direction from the first side surface to the second side surface. The plurality of first prism bodies are disposed to align along a second direction parallel to the first major surface and perpendicular to the first direction.

A vertex angle of the plurality of first prism bodies on an opposite side to the first major surface is a substantially right angle. A refractive index of the plurality of first prism bodies is higher than a refractive index of the light guide plate. According to another embodiment, a light guide body includes a light guide plate, a first prism array unit, and a second prism array unit. The light guide plate has a first major surface, a second major surface on an opposite side to the first major surface, a first side surface, and a second side surface on an opposite side to the first side surface. The first prism array unit is provided on the first major surface of the light guide plate to be in contact with the first major surface. The second prism array unit is provided on the second major surface of the light guide plate to be in contact with the second major surface. The first prism array unit includes a plurality of first prism bodies. Each of the plurality of first prism bodies extends along a first direction from the first side surface to the second side surface. The plurality of first prism bodies are disposed to align along a second direction parallel to the first major surface and perpendicular to the first direction. A vertex angle of the plurality of first prism bodies on an opposite side to the first major surface is a substantially right angle. The second prism array unit includes a plurality of second prism bodies. Each of the plurality of second prism bodies extends along the first direction. The plurality of second prism bodies are disposed to align along the second direction. A vertex angle of the plurality of second prism bodies on an opposite side to the second major surface is a substantially right angle.

According to another embodiment, a surface light source includes a light guide body and a light source. The light guide body includes a light guide plate and a first prism array unit. The light guide plate has a first major surface, a first side surface, and a second side surface on an opposite side to the first side surface. The first prism array unit is provided on the first major surface of the light guide plate to be in contact with the first major surface. The first prism array unit includes a plurality of first prism bodies. Each of the plurality of first prism bodies extends along a first direction from the first side surface to the second side surface. The plurality of first prism bodies are disposed to align along a second direction parallel to the first major surface and perpendicular to the first direction. A vertex angle of the plurality of first prism bodies on an opposite side to the first major surface is a substantially right angle. A refractive index of the plurality of first prism bodies is higher than a refractive index of the light guide plate. The light source faces the first side surface of the light guide plate, and is configured to enter light into the light guide plate through the first side surface.

According to another embodiment, a surface light source includes a light guide body and a light source. The light guide body includes a light guide plate, a first prism array unit, and a second prism array unit. The light guide plate has a first major surface, a second major surface on an opposite side to the first major surface, a first side surface, and a second side surface on an opposite side to the first side surface. The first prism array unit is provided on the first major surface of the light guide plate to be in contact with the first major surface. The second prism array unit is provided on the second major surface of the light guide plate to be in contact with the second major surface. The first prism array unit includes a plurality of first prism bodies. Each of the plurality of first prism bodies extends along a first direction from the first side surface to the second side surface. The plurality of first prism bodies are disposed to align along a second direction parallel to the first major surface and perpendicular to the first direction. A vertex angle of the plurality of first prism bodies on an opposite side to the first major surface is a substantially right angle. The second prism array unit includes a plurality of second prism bodies. Each of the plurality of second prism bodies extends along the first direction. The plurality of second prism bodies are disposed to align along the second direction. A vertex angle of the plurality of second prism bodies on an opposite side to the second major surface is a substantially right angle. The light source faces the first side surface of the light guide plate, and is configured to enter light into the light guide plate through the first side surface.

Various embodiments are described hereinafter with reference to the accompanying drawings.

The drawings are schematic or conceptual; and the relationships between the thickness and width of portions, the proportions of sizes among portions, etc., are not necessarily the same as the actual values thereof. Further, the dimensions and proportions may be illustrated differently among drawings, even for identical portions.

In the specification and the drawings, components similar to those described in regard to a drawing thereinabove are marked with the same reference numerals, and a detailed description is omitted as appropriate.

### First Embodiment

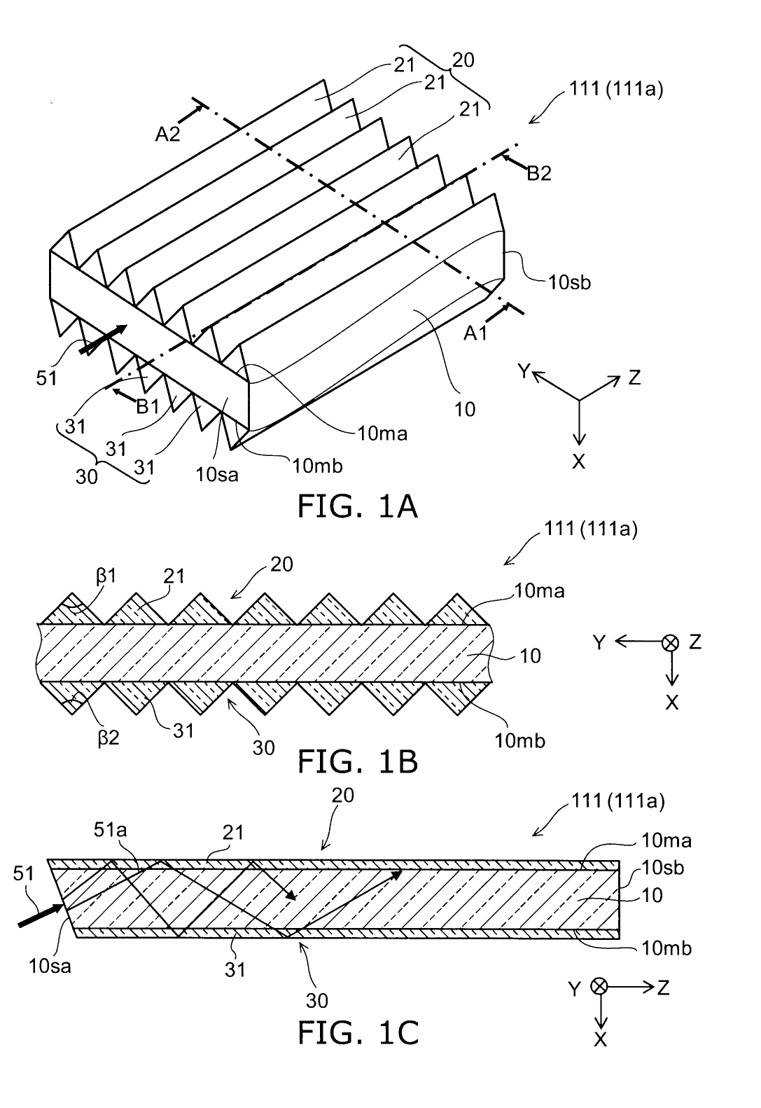

FIG. 1A to FIG. 1C are schematic views illustrating the configuration of a light guide body according to a first embodiment. More specifically, FIG. 1A is a perspective view. FIG. 1B is a cross-sectional view taken along line A1-A2 of FIG. 1A. FIG. 1C is a cross-sectional view taken along line B1-B2 of FIG. 1A.

As shown in FIG. 1A to FIG. 1C, a light guide body 111 according to the embodiment includes a light guide plate 10, a first prism array unit 20, and a second prism array unit 30.

The light guide plate 10 has a first major surface 10ma, a second major surface 10mb, a first side surface 10sa, and a second side surface 10sb. The second major surface 10mb is the surface on the opposite side to the first major surface 10ma. The second side surface 10sb is the surface on the opposite side to the first side surface 10sa.

Light 51 is entered into the light guide plate 10 through the first side surface 10sa. The embodiment is not limited thereto. As described later, light may be entered also through the second side surface 10sb.

Here, the direction from the first side surface 10sa to the second side surface 10sb is defined as a Z-axis direction. The direction from the first major surface 10ma to the second major surface 10mb is defined as an X-axis direction. The direction perpendicular to both the Z-axis direction and the X-axis direction is defined as a Y-axis direction. The Y-axis direction is parallel to the first major surface 10ma and perpendicular to the Z-axis direction. The Z-axis direction is defined as a first direction. The Y-axis direction is defined as a second direction. The X-axis direction is defined as a third direction.

The first prism array unit 20 is provided on the first major surface 10ma of the light guide plate 10 to be in contact with the first major surface 10ma.

The second prism array unit 30 is provided on the second major surface 10mb of the light guide plate 10 to be in contact with the second major surface 10mb.

The first prism array unit 20 includes a plurality of first prism bodies 21.

Each of the plurality of first prism bodies 21 extends along the Z-axis direction. The plurality of first prism bodies 21 are disposed to align along the Y-axis direction. The vertex angle of the plurality of first prism bodies 21 on the opposite side to the first major surface 10ma (a first vertex angle β1) is a substantially right angle.

The first prism body 21 has two slope faces (a first slope face and a second slope face) and one bottom face. The bottom face is parallel to the first major surface 10ma. One of the two slope faces (the first slope face) is inclined with respect to the first major surface 10ma and is parallel to the Z-axis direction. The other of the two slope faces (the second slope face) is inclined with respect to the first major surface 10ma and is parallel to the Z-axis direction. The first slope face and the second slope face are substantially flat. The plane including the second slope face intersects with the plane including the first slope face. The line at which the plane including the second slope face intersects with the plane including the first slope face is parallel to the Z-axis direction.

The second prism array unit 30 includes a plurality of second prism bodies 31.

Each of the plurality of second prism bodies 31 extends along the Z-axis direction. The plurality of second prism bodies 31 are disposed to align along the Y-axis direction. The vertex angle of the plurality of second prism bodies 31 on the opposite side to the second major surface 10mb (a second vertex angle β2) is a substantially right angle.

The second prism body 31 has two slope faces (a third slope face and a fourth slope face) and one bottom face. The bottom face is parallel to the second major surface 10mb. One of the two slope faces (the third slope face) is inclined with respect to the second major surface 10mb and is parallel to the Z-axis direction. The other of the two slope faces (the fourth slope face) is inclined with respect to the second major surface 10mb and is parallel to the Z-axis direction. The third slope face and the fourth slope face are substantially flat. The plane including the fourth slope face intersects with the plane including the third slope face. The line at which the plane including the fourth slope face intersects with the plane including the third slope face is parallel to the Z-axis direction.

As shown in FIG. 1C, light 51 enters through the first side surface 10sa of the light guide plate 10. The light 51 is reflected at the surfaces (inner side faces) of the first prism array unit 20 and the second prism array unit 30 and is propagated through the light guide plate 10. The direction of the optical axis of the light 51 entering through the first side surface 10sa is inclined with respect to the X-axis direction, for example. That is, the light 51 entering through the first side surface 10sa has a component in a direction inclined with respect to the X-axis direction. The light 51 entering through the first side surface 10sa has a component in a direction inclined with respect to both the X-axis direction and the Z-axis direction. Thereby, the light 51 is reflected at the surfaces (inner side faces) of the first prism array unit 20 and the second prism array unit 30, and is propagated in the light guide plate 10. The reflection mentioned above is, for example, total internal reflection.

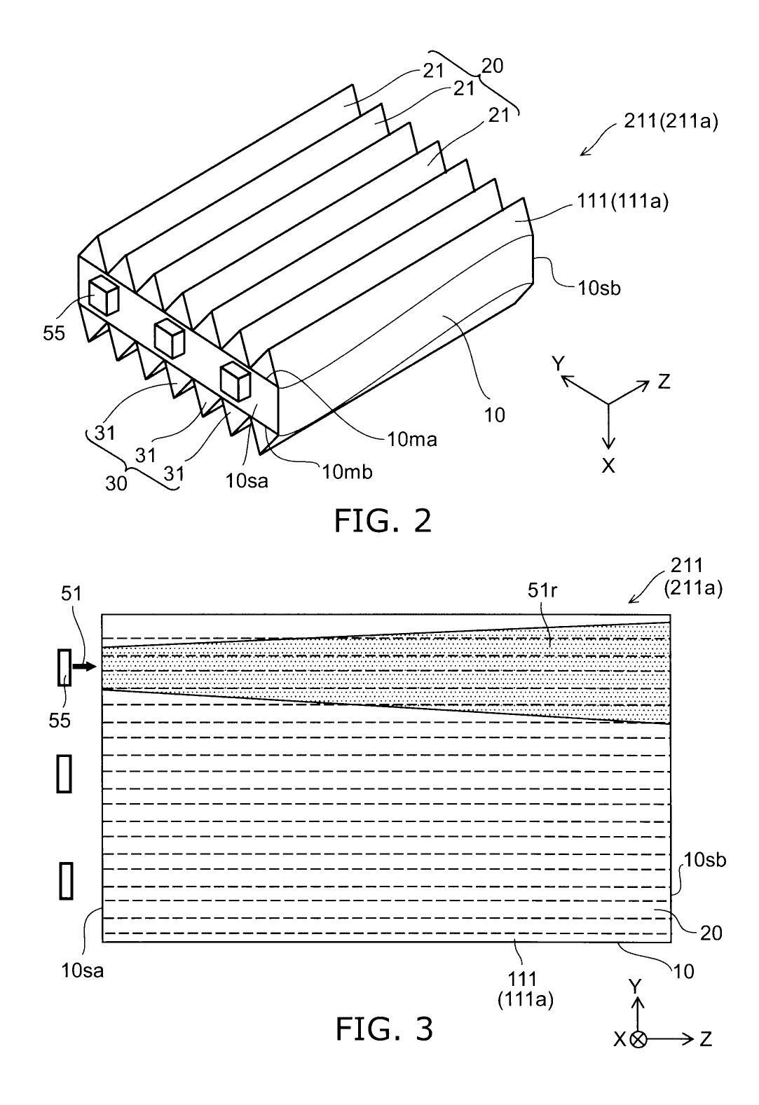

FIG. 2 is a schematic perspective view illustrating the configuration of a surface light source according to the first embodiment.

As shown in FIG. 2, a surface light source 211 according to the embodiment includes the light guide body 111 and light sources 55.

The light sources 55 are facing the first side surface 10sa of the light guide plate 10. The light source 55 enters light 51 into the light guide plate 10 through the first side surface 10sa. The surface light source 211 is a practical application of the light guide body 111 according to the embodiment. An LED, for example, may be used for the light source 55. However, in the embodiment, the light source 55 is arbitrary.

The light guide body 111 and the surface light source 211 having such configurations can provide a light guide body and a surface light source excellent in the controllability of the spread of the light that has entered.

FIG. 3 is a schematic plan view illustrating the operation of the light guide body and the surface light source according to the first embodiment.

As shown in FIG. 3, the light 51 that has entered through the first side face 10sa is propagated along the Z-axis direction. At this time, the width (the width along the Y-axis direction) of a light guide region 51r, which is the width of the light 51, is controlled. That is, the embodiment can narrow the width of the light guide region 51r.

Hereinbelow, the characteristics of the light guide body (and the surface light source) according to the embodiment are described along with reference examples. Here, in the light guide body 111 (and the surface light source 211), the refractive index of the first prism body 21 and the refractive index of the second prism body 31 are assumed to be equal to the refractive index of the light guide plate 10. In another light guide body 111a according to the embodiment, the refractive index of the first prism body 21 and the refractive index of the second prism body 31 are set higher than the refractive index of the light guide plate 10. Otherwise, the configuration is similar to that of the light guide body 111. Another surface light source 211a according to the embodiment includes the light guide body 111a and the light sources 55.

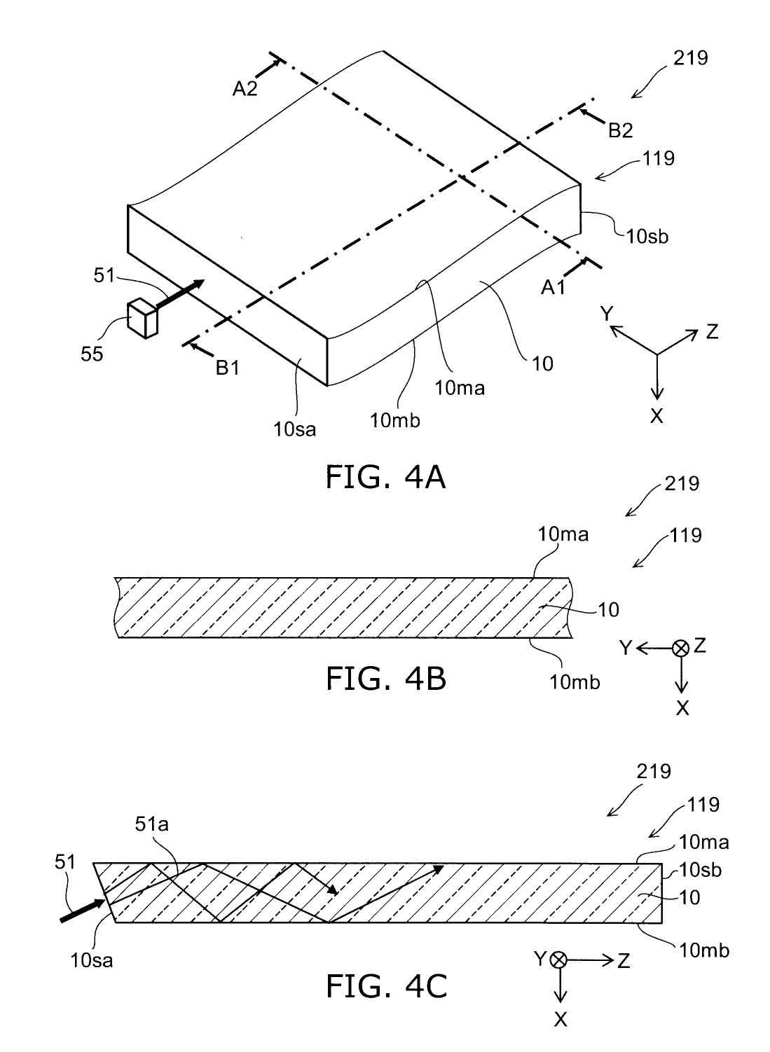

FIG. 4A to FIG. 4C are schematic views illustrating the configuration of a light guide body and a surface light source of a reference example.

More specifically, FIG. 4A is a perspective view. FIG. 4B is a cross-sectional view taken along line A1-A2 of FIG. 4A. FIG. 4C is a cross-sectional view taken along line B1-B2 of FIG. 4A.

As shown in FIG. 4A to FIG. 4C, a light guide body 119 of the reference example includes the light guide plate 10, but does not include the first prism array unit 20 and the second prism array unit 30. A surface light source 219 of the reference example includes the light guide body 119 thus configured and the light source 55.

A simulation is carried out for the optical characteristics of the light guide body 111 (and the surface light source 211) and the light guide body 111a (and the surface light source 211a) according to the embodiment and the light guide body 119 (and the surface light source 219) of the reference example. More specifically, a simulation is carried out for the intensity of the light 51 that has entered through the first side surface 10sa of the light guide body at the second side surface 10sb.

In this simulation, in regard to the light guide plate 10, the refractive index is set to 1.49, the length in the Z-axis direction is set to 40 cm, the length in the Y-axis direction is set to 20 cm, and the length in the X-axis direction (thickness) is set to 9.9 mm. The width along the Y-axis direction of the first prism body 21 and the second prism body 31 is set to 0.5 mm, and the vertex angle (the first vertex angle β1 and the second vertex angle β2) is set to 90 degrees. In the light guide body 111, the refractive index of the first prism body 21 and the second prism body 31 is set to 1.49. In the light guide body 111a, the refractive index of the first prism body 21 and the second prism body 31 is set to 1.52. It is assumed that the light 51 has a spread angle of ±10 degrees.

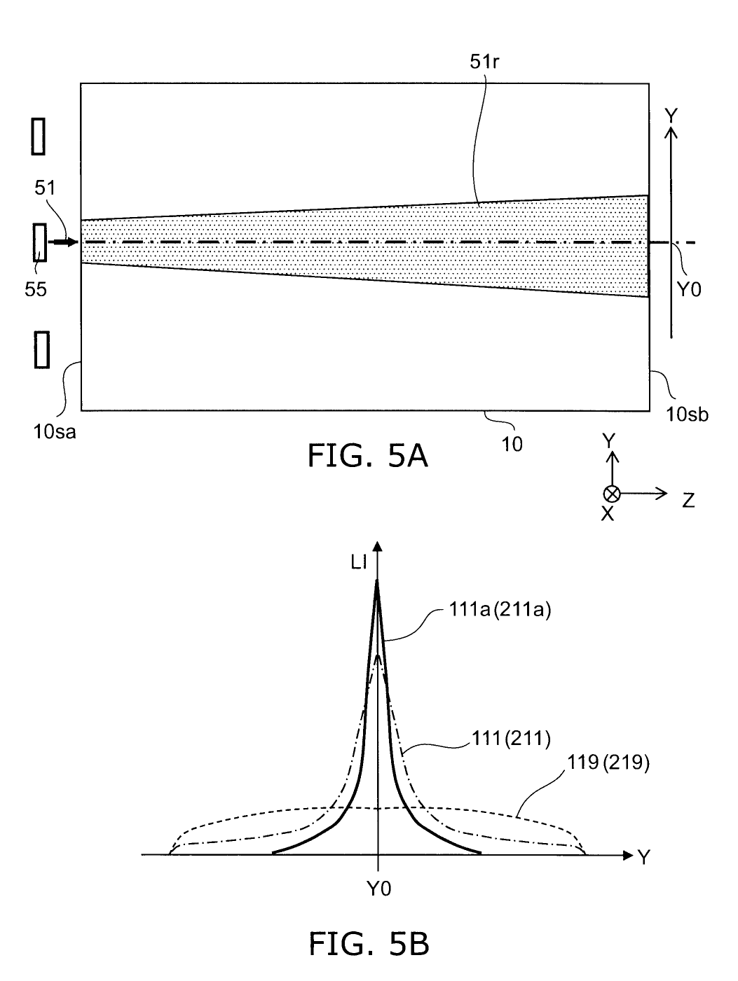

FIG. 5A and FIG. 5B are schematic diagrams illustrating the characteristics of the light guide body and the surface light source.

FIG. 5A shows the coordinate system and the position for the optical characteristics. As shown in FIG. 5A, the position along the Y-axis direction of the center of the light source 55 (the position where the light 51 enters) is defined as a reference position Y0.

FIG. 5B illustrates the simulation results. The horizontal axis of FIG. 5B represents the position along the Y-axis direction. The vertical axis represents the relative luminance LI corresponding to the intensity of light at the second side surface 10sb. As shown in FIG. 5B, in the light guide body 119 (and the surface light source 219) of the reference example, the relative luminance LI exhibits a wide distribution along the Y-axis direction. That is, since the spread angle of the light 51 is ±10 degrees, the light 51 is propagated in the direction based on this spread angle when the light 51 is propagated in the light guide body 119. Consequently, the relative luminance LI at the second side surface 10sb exhibits a wide distribution along the Y-axis direction.

In contrast, in the light guide body 111 (and the surface light source 211) according to the embodiment, the relative luminance LI has a very high peak at the reference position Y0. That is, although the incident light 51 has a spread angle of ±10 degrees, the spread angle of the light 51 is controlled to be narrow when the light 51 is propagated through the light guide body 111.

Furthermore, in the other light guide body 111a (and the other surface light source 211a) according to the embodiment, the relative luminance LI has a still higher peak at the reference position Y0. That is, the spread angle of the light 51 is controlled to be still narrower when the light 51 is propagated through the light guide body 111.

In the light guide bodies 111 and 111a according to the embodiment, when the light 51 enters the light guide plate 10 through the first side surface 10sa, the light 51 propagated while, for example, being totally reflected at the prism planes of the first prism body 21 and the second prism body 31. At this time, the spread of the light 51 in the Y-axis direction is suppressed when the light 51 is propagated in the light guide body.

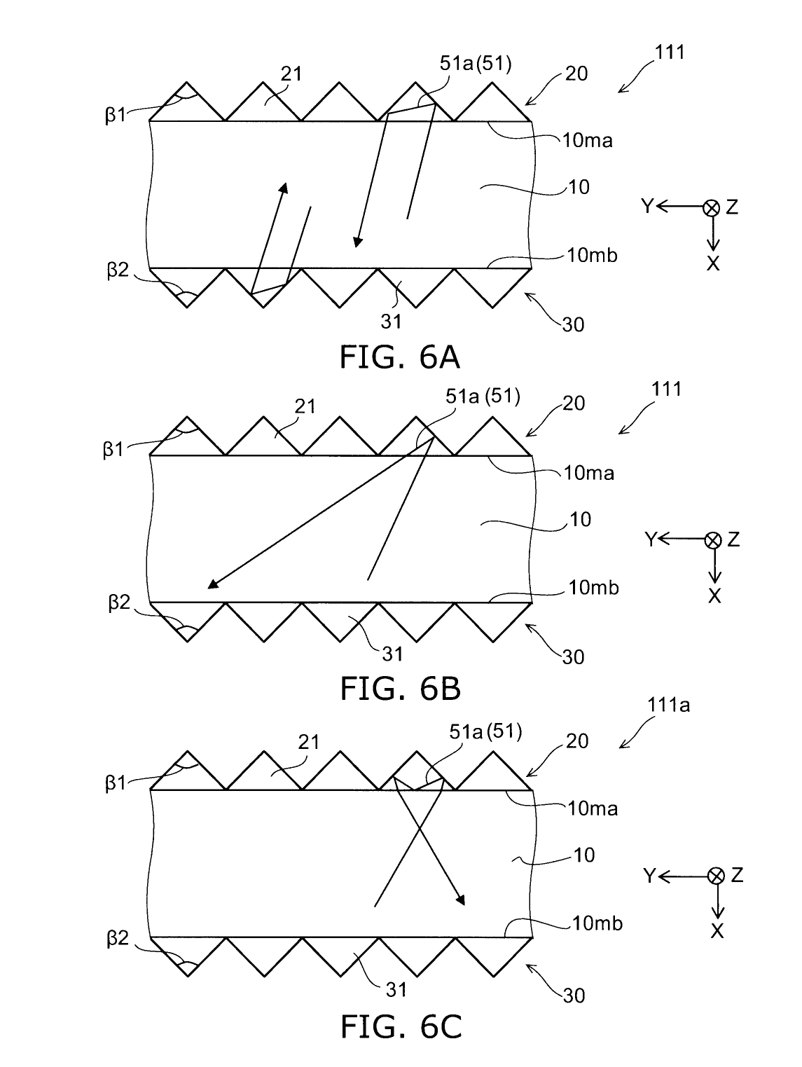

FIG. 6A to FIG. 6C are schematic views illustrating the characteristics of the light guide body according to the embodiment.

More specifically, the drawings are those when the light guide body 111 or the light guide body 111a is viewed from the Z-axis direction. The light indicated by a light path 51a is propagated along the Z-axis direction. The drawings show states where the light path 51a is projected onto the X-Y plane.

As shown in FIG. 6A, the light 51 is reflected at the slope faces of the first prism body 21 and the second prism body 31. At this time, since the vertex angle is a right angle, the light that has entered the prism is retroreflected for the XY component by total internal reflection. That is, for example, the light 51 incident on the slope face of the first prism body 21 is reflected in a direction parallel to the incident direction in the X-Y plane. This reflection is, for example, total internal reflection. The reflected light 51 reaches the second prism body 31 and is similarly retroreflected. As a result of repeating this, the propagation of the light 51 along the Y-axis direction is suppressed. That is, the spread along the Y-axis direction of the light 51 propagated in the light guide plate 10 (the light guide bodies 111 and 111a) is suppressed.

Thus, the light guide bodies 111 and 111a according to the embodiment can provide a light guide body and a surface light source excellent in the controllability of the spread of the light that has entered.

Furthermore, the controllability is further improved in the light guide body 111a than in the light guide body 111. For example, as shown in FIG. 6B, there is a case where part of the light 51 is not retroreflected in the light guide body 111. That is, there is a case where light 51 having a large component in the Y-axis direction is reflected at one slope face of the first prism body 21 and then returns to the light guide body 10 without being reflected at the other slope face of the first prism body 21. In this case, retroreflection is not brought about. Consequently, the light 51 is propagated in a direction greatly inclined to the Y-axis direction. Thus, the suppression of the spread along the Y-axis direction of the light 51 may have limitations.

At this time, by setting the refractive index of the first prism body 21 and the refractive index of the second prism body 31 higher than the refractive index of the light guide plate 10, the suppression of the spread along the Y-axis direction of the light 51 can be improved.

That is, as shown in FIG. 6C, in the light guide body 111a, for example, the light 51 reflected at the first prism body 21 is totally reflected at the interface between the first prism body 21 (the first prism array unit 20) and the light guide plate 10. Then, the light 51 is totally reflected at the slope face of the first prism body 21 and returns to the light guide plate 10. As a consequence, also in the case of light 51 having a large component in the Y-axis direction, the spread along the Y-axis direction of the light 51 can be sufficiently suppressed.

In the light guide body according to the embodiment, the relationships between the refractive index of the first prism body 21, the refractive index of the second prism body 31, and the refractive index of the light guide plate 10 are arbitrary. However, it is notable to set at least one of the refractive index of the first prism body 21 and the refractive index of the second prism body 31 higher than the refractive index of the light guide plate 10 as described above. Thereby, the spread angle of the light 51 can be controlled to be still narrower.

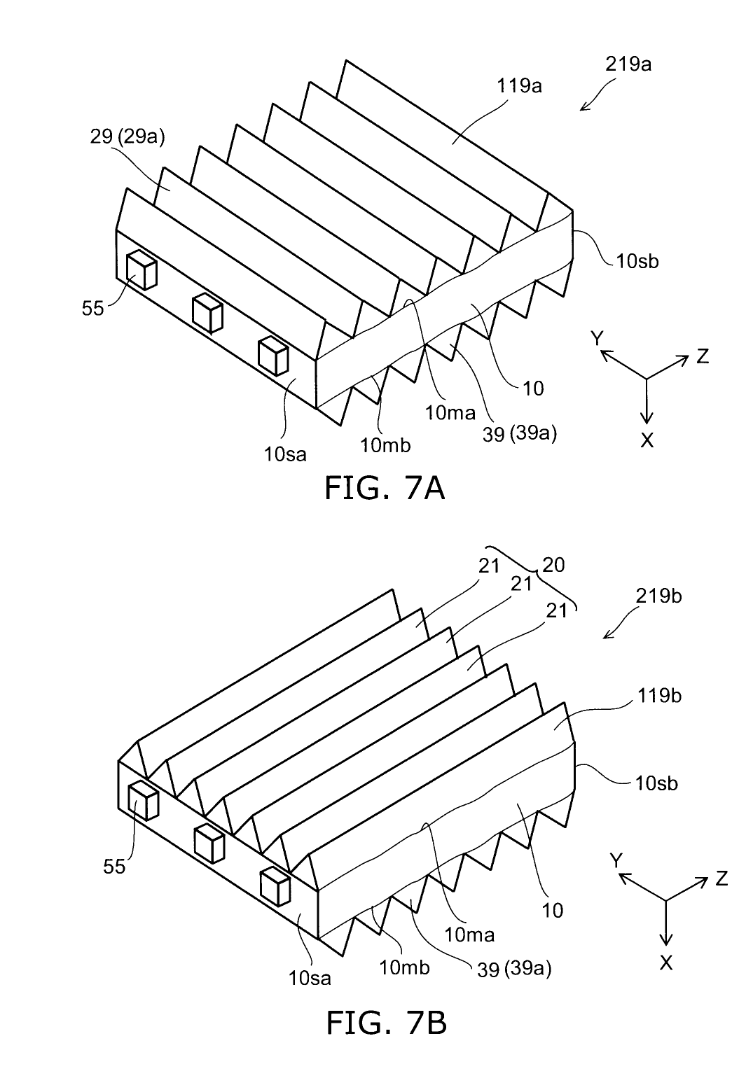

FIG. 7A and FIG. 7B are schematic perspective views illustrating the configurations of light guide bodies and surface light sources of reference examples.

As shown in FIG. 7A, also a light guide body 119a of a reference example includes the light guide plate 10, a first prism array unit 29, and a second prism array unit 39. The light guide plate 10 has the first major surface 10ma, the second major surface 10mb, the first side surface 10sa, and the second side surface 10sb. The light 51 is entered through the first side surface 10sa. That is, a surface light source 219a of the reference example includes the light guide body 119a and the light sources 55 that are facing the first side surface 10sa of the light guide plate 10 and enter light into the light guide plate 10 through the first side surface 10sa.

In the light guide body 119a, the first prism array unit 29 includes a plurality of first prism bodies 29a extending along the Y-axis direction. The second prism array unit 39 includes a plurality of second prism bodies 39a extending along the Y-axis direction.

In other words, in the light guide body 119a of the reference example, the extending direction of the prism body in the first prism array unit 29 and the second prism array unit 39 is rotated by 90 degrees with respect to the case of the light guide body 111 according to the embodiment. It can also be assumed that the light guide body 119a of the reference example has a configuration in which light is entered not through the first side surface 10sa but through another side surface orthogonal to the first side surface 10sa and the second side surface 10sb in the light guide body 111 according to the embodiment.

In the light guide body 119a (and the surface light source 219a) of the reference example, the light entering through the first side surface 10sa toward the second side surface 10sb is reflected by the first prism body 29a and the second prism body 39a extending along the Y-axis direction, and is easily propagated along the Y-axis direction. Therefore, the light 51 spreads along the Y-axis direction. Consequently, in the light guide body 119a (and the surface light source 219a ) of the reference example, the spread of the light that has entered is large and the controllability of light spread is low.

As shown in FIG. 7B, also a light guide body 119b of a reference example includes the light guide plate 10, the first prism array unit 20, and the second prism array unit 39. The light guide plate 10 has the first major surface 10ma, the second major surface 10mb, the first side surface 10sa, and the second side surface 10sb. The light 51 is entered through the first side surface 10sa. A surface light source 219b includes the light guide body 119b and the light sources 55 that are facing the first side surface 10sa of the light guide plate 10 and enter light into the light guide plate 10 through the first side surface 10sa.

Also in the light guide body 119b, the first prism array unit 20 includes the plurality of first prism bodies 21 extending along the Z-axis direction. On the other hand, the second prism array unit 39 includes the plurality of second prism bodies 39a extending along the Y-axis direction. In other words, it can be assumed that the light guide body 119a of the reference example has a configuration in which the second prism array unit 30 in the light guide body 111 according to the embodiment is rotated by 90 degrees.

In the light guide body 119b (and the surface light source 219b) of the reference example, it is considered that the spread along the Y-axis direction of the light 51 entering through the first side surface 10sa toward the second side surface 10sb is suppressed by the first prism body 21 extending along the Z-axis direction. However, the second prism body 39a extending along the Y-axis direction does not suppress the spread along the Y-axis direction of the light 51. Therefore, the light 51 spreads along the Y-axis direction. Consequently, in the light guide body 119b (and the surface light source 219b) of the reference example, the spread of the light that has entered is large and the controllability of light spread is low.

In contrast, as described above, in the light guide body 111 (and the surface light source 211) according to the embodiment, the spread along the Y-axis direction of the light 51 is suppressed by both the first prism body 21 and the second prism body 31 extending along the Z-axis direction. The spread of light can be made still narrower by the light guide body 111a (and the surface light source 211a) in which at least one of the refractive index of the first prism body 21 and the refractive index of the second prism body 31 is set higher than the refractive index of the light guide plate 10.

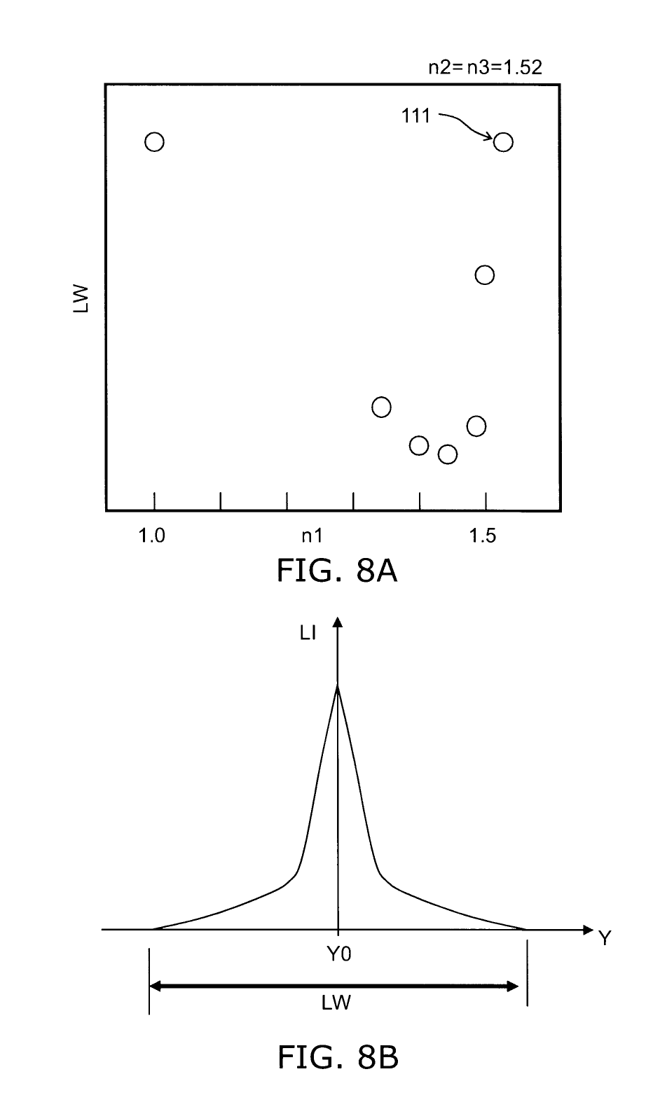

FIG. 8A and FIG. 8B are schematic diagrams illustrating the characteristics of the light guide body and the surface light source according to the first embodiment.

More specifically, FIG. 8A shows the simulation results of the relationship between the difference between the refractive index of the first prism body 21 and the second prism body 31 and the refractive index of the light guide plate 10 and the width (the width along the Y-axis direction) of light. In this simulation, the refractive index of the first prism body 21 (refractive index n2) and the refractive index of the second prism body 31 (refractive index n3) are set to a fixed value of 1.52, and the refractive index of the light guide plate 10 (refractive index n1) is changed.

As shown in FIG. 8B, the width (the width along the Y-axis direction) in which the intensity of light (the relative luminance LI) at the second side surface 10sb is not substantially zero is defined as a light width LW.

The horizontal axis of FIG. 8A represents the refractive index n1 of the light guide plate 10, and the vertical axis represents the light width LW (relative values).

As shown in FIG. 8A, the light width LW becomes significantly small in a region of the refractive index n1 of the light guide plate 10 of not less than 1.35 and not more than 1.50. The condition that the refractive index n1 of the light guide plate 10 is 1.52 corresponds to the light guide body 111 according to the embodiment (a configuration in which the refractive index of the light guide plate 10 is equal to the refractive index of the first prism body 21 and the second prism body 31). Furthermore, the condition that the refractive index n1 of the light guide plate 10 is less than 1.52 corresponds to the light guide body 111a according to the embodiment (a configuration in which the refractive index of the light guide plate 10 is lower than the refractive index of the first prism body 21 and the second prism body 31).

Here, the ratio of the refractive index n1 of the light guide plate 10 to the refractive index n2 of the first prism body 21 and the refractive index n3 of the second prism body 31 is defined as a refractive index ratio nr=n1/n2 (=n1/n3). In the conditions of this simulation, the refractive index n1 of the light guide plate 10 being 1.35 corresponds to the refractive index ratio nr being 0.888. The refractive index n1 of the light guide plate 10 being 1.50 corresponds to the refractive index ratio nr being 0.987. Therefore, in the light guide body 111a, the ratio of the refractive index n1 of the light guide plate 10 to the refractive index n2 of the first prism body 21 and the refractive index n3 of the second prism body 31 is preferably not less than 0.888 and not more than 0.987. Thereby, the light width LW can be more reduced and the spread of the width of light can be more suppressed.

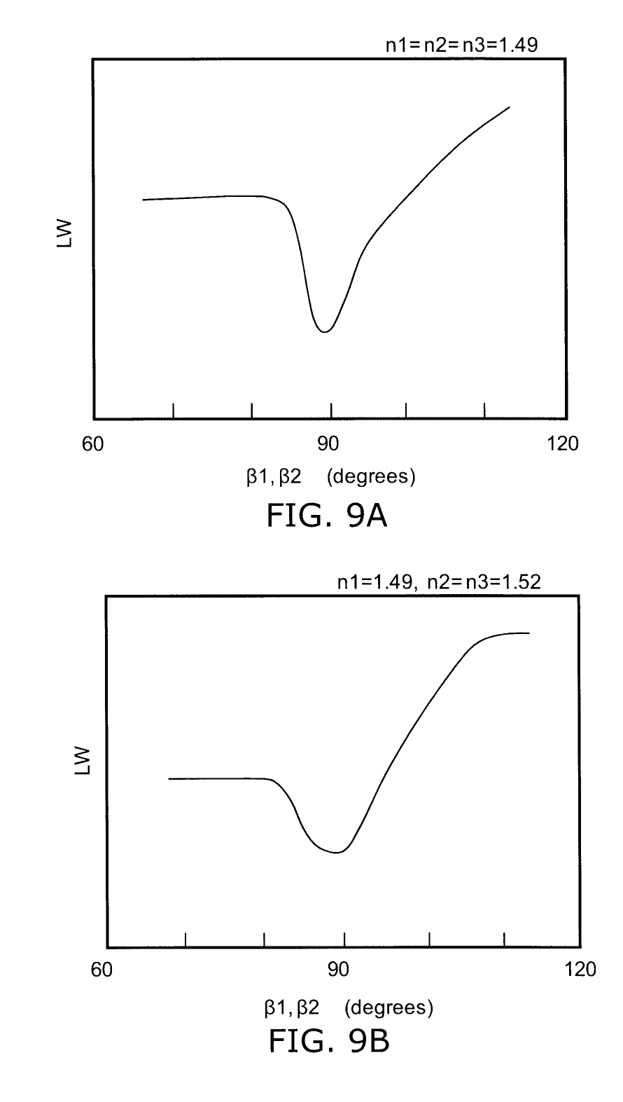

FIG. 9A and FIG. 9B are graphs illustrating the characteristics of the light guide body and the surface light source according to the first embodiment.

More specifically, the drawings show the simulation results of the light width LW when the vertex angle of the first prism body 21 (the first vertex angle β1) and the vertex angle of the second prism body 31 (the second vertex angle β2) are changed. FIG. 9A corresponds to the case where n1=n2=n3=1.49. FIG. 9B corresponds to the case where n1=1.49 and n2=n3=1.52. In this simulation, it is assumed that the first vertex angle β1 is equal to the second vertex angle β2. The horizontal axis of the drawings represents the first vertex angle β1 (the second vertex angle β2). The vertical axis represents the light width LW.

As shown in FIG. 9A, in the case where n1=n2=n3=1.49, the light width LW is small in a region of the vertex angle (the first vertex angle β1 and the second vertex angle β2) of not less than 80 degrees and not more than 100 degrees. The light width LW becomes small rapidly at vertex angles not less than 84 degrees and not more than 97 degrees. The light width LW is very small at vertex angles not less than 86 degrees and not more than 94 degrees.

As shown in FIG. 9B, in the case where n1=1.49 and n2=n3=1.52, the light width LW is small in a region of the vertex angle (the first vertex angle β1 and the second vertex angle β2) of not less than 80 degrees and not more than 95 degrees. The light width LW becomes small rapidly at vertex angles not less than 83 degrees and not more than 93 degrees. The light width LW is very small at vertex angles not less than 85 degrees and not more than 92 degrees.

In the embodiment, the vertex angle of the first prism body 21 (the first vertex angle β1) and the vertex angle of the second prism body 31 (the second vertex angle β2) may not be strictly right angles.

That is, in the case where n1=n2=n3, the vertex angle of the first prism body 21 (the first vertex angle β1) and the vertex angle of the second prism body 31 (the second vertex angle β2) are set not less than 80 degrees and not more than 110 degrees. The vertex angle is preferably not less than 84 degrees and not more than 97 degrees. The vertex angle is more preferably not less than 86 degrees and not more than 94 degrees. Thereby, the light width LW can be more reduced.

In the case where n2 and n3 are larger than n1, the vertex angle of the first prism body 21 (the first vertex angle β1) and the vertex angle of the second prism body 31 (the second vertex angle β2) are set not less than 80 degrees and not more than 95 degrees. The vertex angle is preferably not less than 83 degrees and not more than 93 degrees. The vertex angle is more preferably not less than 85 degrees and not more than 92 degrees. Thereby, the light width LW can be more reduced.

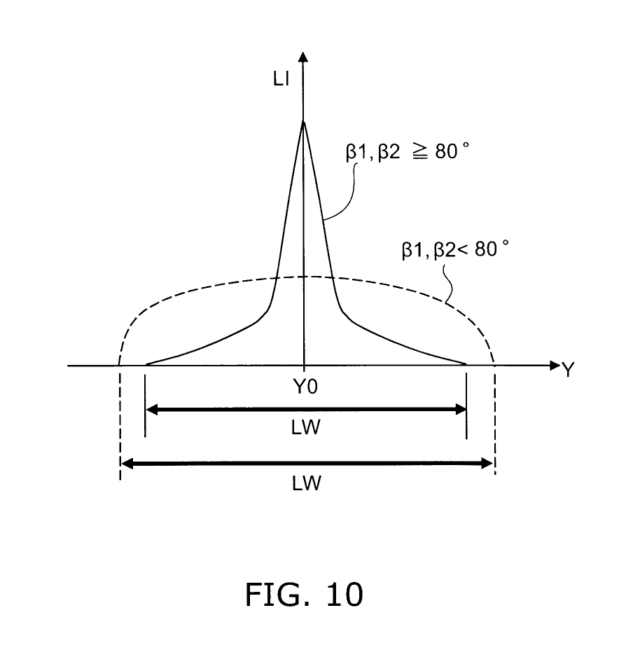

FIG. 10 is a graph illustrating the characteristics of the light guide body and the surface light source.

The horizontal axis of the drawing represents the position along the Y-axis direction. The vertical axis represents the intensity of light (the relative luminance LI) at the second side surface 10sb.

As shown in FIG. 10, in the case where the vertex angle of the first prism body 21 (the first vertex angle β1) and the vertex angle of the second prism body 31 (the second vertex angle β2) are not less than 80 degrees, the relative luminance LI has a peak at the reference position Y0. On the other hand, in the case where the vertex angle (the first vertex angle β1 and the second vertex angle β2) is less than 80 degrees, a broad distribution having no peak is exhibited.

In FIG. 9A and FIG. 9B, the light width LW is almost constant when the vertex angle is less than 80 degrees. However, this is not notable because the characteristics illustrated in FIG. 10 are exhibited. In view of this, in the embodiment, the vertex angle is set not less than 80 degrees.

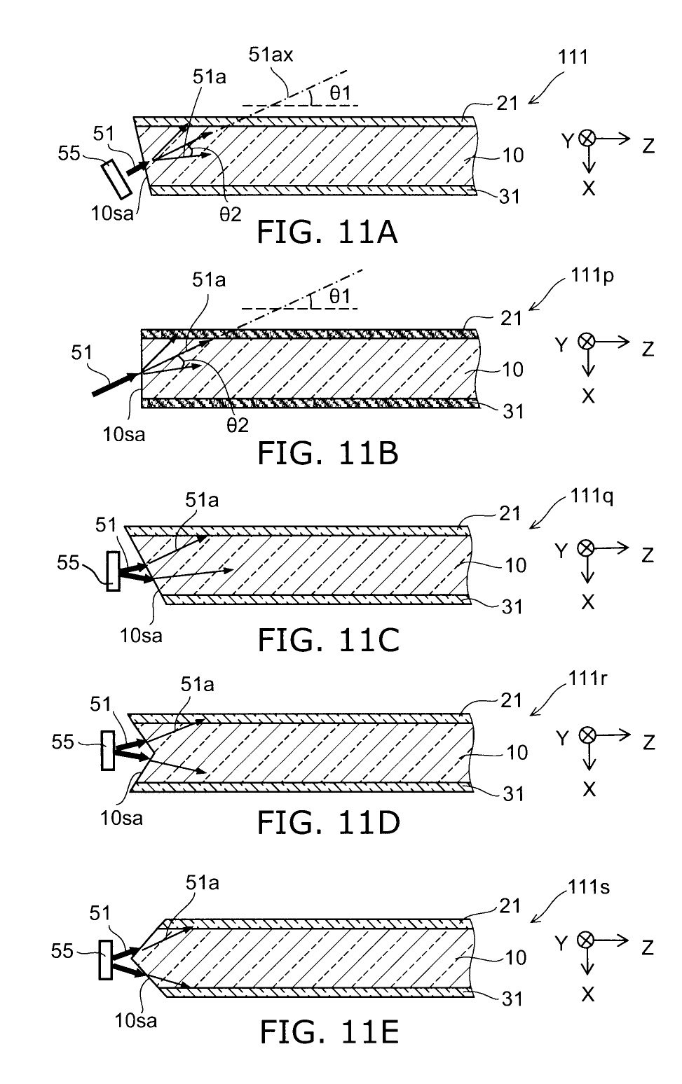

FIG. 11A to FIG. 11E are schematic views illustrating the configurations of light guide bodies according to the first embodiment.

As shown in FIG. 11A, in the light guide body 111 according to the embodiment, the direction of the optical axis 51ax of the light 51 when the light 51 is incident on the first side surface 10sa is inclined with respect to the X-axis direction. Thereby, the light 51 is transmitted through the light guide plate 10, reflected at the surfaces of the first prism array unit 20 and the second prism array unit 30, and propagated in the light guide plate 10. This reflection is, for example, total internal reflection.

Furthermore, the angle between the direction of the optical axis 51ax and the Z-axis direction (angle θ1 shown in FIG. 11A) is larger than the spread angle of light when the light 51 is incident on the first side surface 10sa (angle θ2 shown in FIG. 11A). In other words, in the case where the light 51 has a certain spread, the light 51 is incident on the first side surface 10sa with an inclination from the first major surface 10ma by an angle larger than the angle of that spread.

The light 51 entering through the first side surface 10sa has a component in a direction inclined with respect to the X-axis direction. The light of this component is reflected at the surfaces of the first prism array unit 20 and the second prism array unit 30 and can be propagated in the light guide plate 10.

In the case where the light 51 has a spread, the direction of the optical axis 51ax of the light 51 when the light 51 is incident on the first side surface 10sa may be parallel to the Z-axis direction. The direction of the optical axis 51ax is preferably perpendicular to the Y-axis direction. In other words, preferably the direction of the optical axis 51ax has substantially no component in the Y-axis direction and has a component in the X-axis direction. Thereby, the propagation along the Y-axis direction of the light 51 can be suppressed. The component in the Y-axis direction of the light 51 is preferably as small as possible.

In the light guide body 111 illustrated in FIG. 11A, the first side surface 10sa is inclined with respect to the Z-axis direction. More specifically, the first side surface 10sa includes an inclined surface inclined with respect to both the Z-axis direction and the X-axis direction. The light source 55 may enter the light 51 substantially perpendicularly to the inclined surface. Thereby, more light 51 can be caused to reach the prism array unit.

As shown in FIG. 11B, in another light guide body 111p according to the embodiment, the first side surface 10sa is perpendicular to the Z-axis direction. Also in this case, the direction of the optical axis 51ax of the light 51 when the light 51 is incident on the first side surface 10sa is inclined with respect to the X-axis direction.

As shown in FIG. 11C, in another light guide body 111q according to the embodiment, the first side surface 10sa is inclined with respect to the Z-axis direction. The first side surface 10sa includes an inclined surface inclined with respect to both the Z-axis direction and the X-axis direction. In this specific example, the light 51 is incident on the first side surface 10sa along the Z-axis direction. In other words, the light 51 is incident on the first side surface 10sa in a direction inclined with respect to the inclined surface of the first side surface 10sa. At the first side surface 10sa, the direction of the optical axis 51ax of the light 51 that has entered the light guide plate 10 inclines with respect to the X-axis direction due to the refraction effect. Thereby, the light 51 is transmitted through the light guide plate 10, reflected at the surfaces of the first prism array unit 20 and the second prism array unit 30, and propagated in the light guide plate 10. This reflection is, for example, total internal reflection.

As shown in FIG. 11D, in another light guide body 111r according to the embodiment, the first side surface 10sa includes a recess (groove) extending along the Y-axis direction. In other words, the first side surface 10sa includes two inclined surfaces inclined with respect to the Z-axis direction. At the first side surface 10sa, the direction of the optical axis 51ax of the light 51 that has entered the light guide plate 10 inclines with respect to the X-axis direction due to the refraction effect. Thereby, the light 51 is transmitted through the light guide plate 10, reflected at the surfaces of the first prism array unit 20 and the second prism array unit 30, and propagated in the light guide plate 10. This reflection is, for example, total internal reflection.

As shown in FIG. 11E, in another light guide body 111s according to the embodiment, the first side surface 10sa includes a protrusion extending along the Y-axis direction. In other words, the first side surface 10sa includes two inclined surfaces inclined with respect to the Z-axis direction. Also in this case, the light 51 is transmitted through the light guide plate 10, reflected at the surfaces of the first prism array unit 20 and the second prism array unit 30, and propagated in the light guide plate 10. This reflection is, for example, total internal reflection.

Thus, the first side surface 10sa may include an inclined surface inclined with respect to the Z-axis direction. The inclined surface is, for example, parallel to the Y-axis direction.

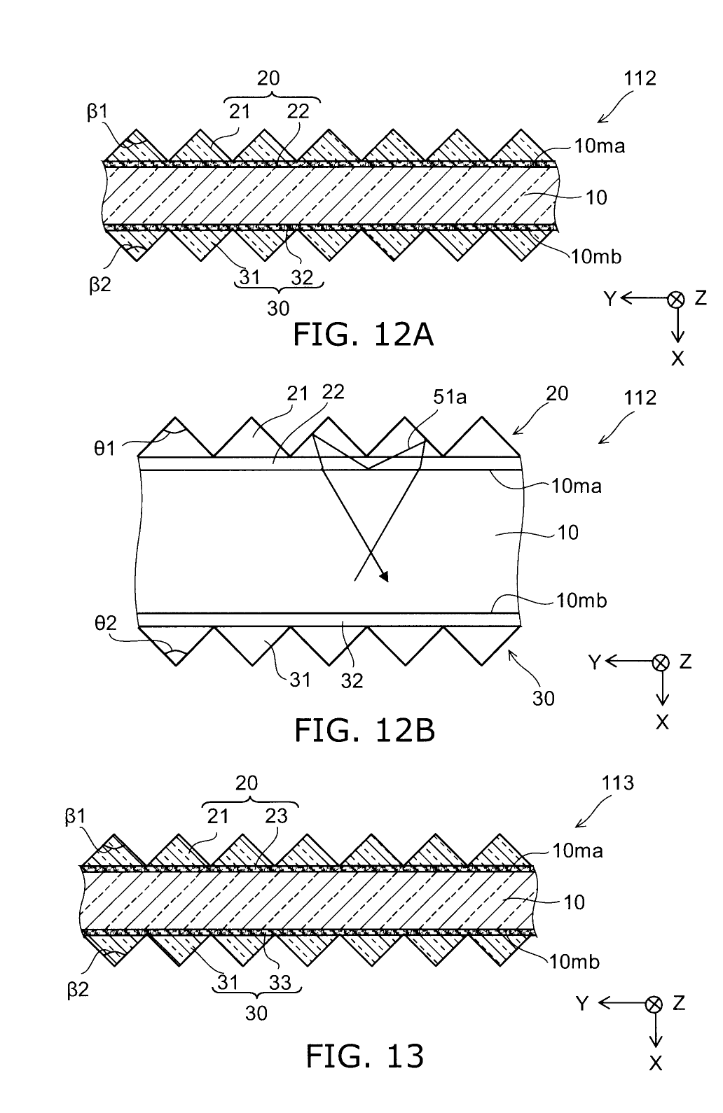

FIG. 12A and FIG. 12B are schematic cross-sectional views illustrating the configuration and operation of a light guide body according to the first embodiment.

As shown in FIG. 12A, in another light guide body 112 according to the embodiment, the first prism array unit 20 further includes a high refractive index layer 22. The high refractive index layer 22 is provided between the light guide plate 10 and the plurality of first prism bodies 21. The high refractive index layer 22 has a refractive index higher than the refractive index of the light guide plate 10. For example, the refractive index of the high refractive index layer 22 is the same as the refractive index of the plurality of first prism bodies 21. The same material as the material used for the first prism body 21, for example, is used for the high refractive index layer 22.

As shown in FIG. 12B, also in the case where the high refractive index layer 22 is provided, for example, the light 51 reflected at the first prism body 21 is totally reflected at the interface between the high refractive index layer 22 (the first prism array unit 20) and the light guide plate 10. Then, the light 51 is totally reflected at the slope face of the first prism body 21 and returns to the light guide plate 10. Consequently, also in the case of light 51 having a large component in the Y-axis direction, the spread along the Y-axis direction of light can be sufficiently suppressed.

In the configuration in which the high refractive index layer 22 is provided, for example, the high refractive index layer 22 may have the function of holding the plurality of first prism bodies 21. For example, a manufacturing method may be used in which the first prism array unit 20 including the high refractive index layer 22 and the plurality of first prism bodies 21 is fabricated, and the first prism array unit 20 is combined with the light guide plate 10. This manufacturing method provides high productivity.

Furthermore, in the light guide body 112, the second prism array unit 30 further includes a high refractive index layer 32. The high refractive index layer 32 is provided between the light guide plate 10 and the plurality of second prism bodies 31. The high refractive index layer 32 has a refractive index higher than the refractive index of the light guide plate 10. For example, the refractive index of the high refractive index layer 32 is the same as the refractive index of the plurality of second prism bodies 31. The same material as the material used for the second prism body 31, for example, is used for the high refractive index layer 32. By providing the high refractive index layer 32, the productivity can be improved.

The high refractive index layer 22 and the high refractive index layer 32 preferably have a thin thickness (length along the X-axis direction). Thereby, the possibility that the light 51 reflected at the surface of a prism body will be reflected toward another prism body can be reduced. This makes it easy to suppress the spread along the Y-axis direction of the light 51.

In the case where the refractive index of the high refractive index layer is the same as the refractive index of the prism body and the materials of them are the same, a method may be used in which the material of a matrix is processed to simultaneously form the high refractive index layer and the prism bodies. In addition, a method may be used in which the prism array unit thus formed is attached to the light guide plate 10. The methods provide high productivity.

Furthermore, the prism array unit may be formed also by a method in which the material of the prism array unit such as a resin material is applied to the major surface of the light guide plate 10, a mold reflecting the form of the prism bodies is pushed against the resin material, and the resin is cured. This method provides high productivity.

Moreover, also a method may be used in which the material of the prism array unit (e.g. a sheet) and the material of the light guide plate 10 (a sheet) are laminated and at the same time an unevenness that forms the prism bodies is formed on the material of the prism array unit. This method provides high productivity.

The refractive index of the high refractive index layer 22 may be different from the refractive index of the plurality of first prism bodies 21. The refractive index of the high refractive index layer 32 may be different from the refractive index of the plurality of second prism bodies 31. The refractive index of the high refractive index layer 22 may be a value between the refractive index of the plurality of first prism bodies 21 and the refractive index of the light guide plate 10. The refractive index of the high refractive index layer 32 may be a value between the refractive index of the plurality of second prism bodies 31 and the refractive index of the light guide plate 10.

FIG. 13 is a schematic cross-sectional view illustrating the configuration of a light guide body according to the first embodiment.

As shown in FIG. 13, in another light guide body 113 according to the embodiment, the first prism array unit 20 further includes a low refractive index layer 23. The low refractive index layer 23 is provided between the light guide plate 10 and the plurality of first prism bodies 21. The low refractive index layer 23 has a refractive index lower than the refractive index of the first prism body 21. For example, the refractive index of the low refractive index layer 23 is the same as the refractive index of the light guide plate 10.

The second prism array unit 30 further includes a low refractive index layer 33. The low refractive index layer 33 is provided between the light guide plate 10 and the plurality of second prism bodies 31. The low refractive index layer 33 has a refractive index lower than the refractive index of the second prism body 31. For example, the refractive index of the low refractive index layer 33 is the same as the refractive index of the light guide plate 10.

Also in the light guide body 113 thus configured, the spread of the light that has entered can be suppressed.

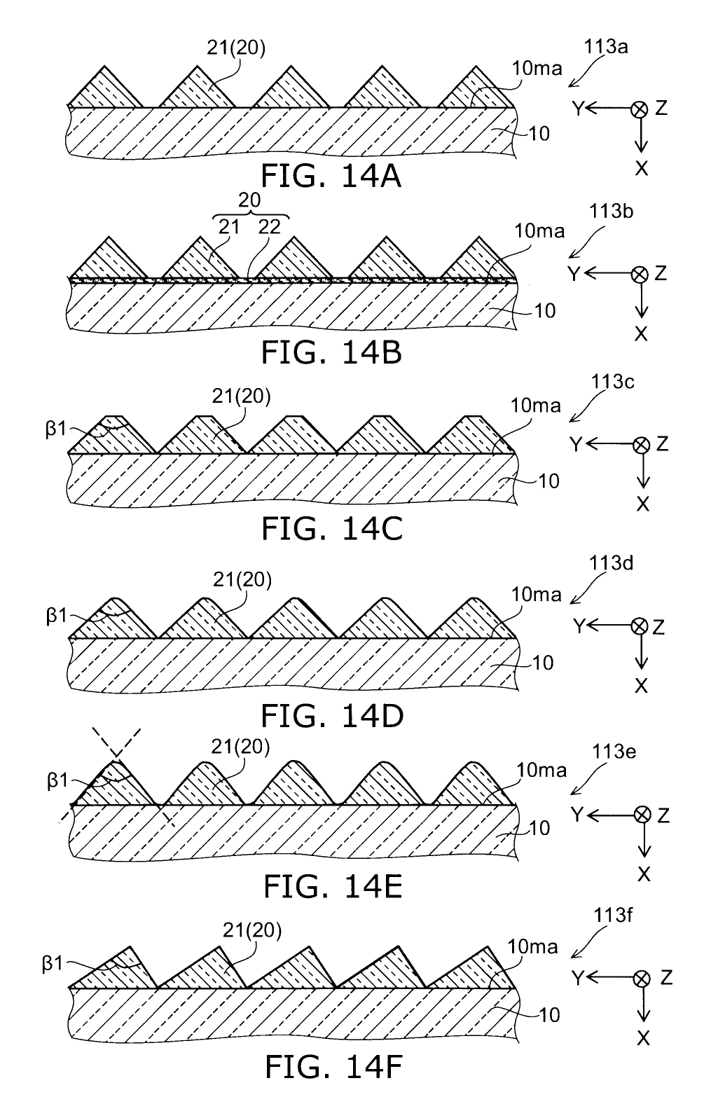

FIG. 14A to FIG. 14F are schematic cross-sectional views illustrating the configurations of light guide bodies according to the first embodiment.

As shown in FIG. 14A, in another light guide body 113a according to the embodiment, the plurality of first prism bodies 21 are away from one another. The light guide plate 10 is exposed between the plurality of first prism bodies 21.

As shown in FIG. 14B, in another light guide body 113b according to the embodiment, the high refractive index layer 22 is provided and the plurality of first prism bodies 21 are away from one another. The high refractive index layer 22 is exposed between the plurality of first prism bodies 21. Also a configuration is possible in which the low refractive index layer 23 is provided and the low refractive index layer 23 is exposed between the plurality of first prism bodies 21.

As shown in FIG. 14C, in another light guide body 113c according to the embodiment, the top of the plurality of first prism bodies 21 is flat. In this case, the vertex angle of the plurality of first prism bodies 21 on the opposite side to the first major surface 10ma (the first vertex angle β1) is the angle between the two slope faces of the plurality of first prism bodies 21. Also in this case, the vertex angle is a right angle (e.g. not less than 80 degrees and not more than 110 degrees).

As shown in FIG. 14D, in another light guide body 113d according to the embodiment, the top of the plurality of first prism bodies 21 is in a curved surface form. In this case, the vertex angle of the plurality of first prism bodies 21 on the opposite side to the first major surface 10ma (the first vertex angle β1) is the angle between the two slope faces (the substantially flat portions) of the plurality of first prism bodies 21. Also in this case, the vertex angle is a right angle (e.g. not less than 80 degrees and not more than 110 degrees).

As shown in FIG. 14E, in another light guide body 113e according to the embodiment, the top of the plurality of first prism bodies 21 is in a curved surface form. The portion between the plurality of first prism bodies 21 (bottom) is in a curved surface form. In this case, the vertex angle of the plurality of first prism bodies 21 on the opposite side to the first major surface 10ma (the first vertex angle β1) is the angle between the two slope faces (the substantially flat portions) of the plurality of first prism bodies 21. Also in this case, the vertex angle is a right angle (e.g. not less than 80 degrees and not more than 110 degrees).

As shown in FIG. 14F, in another light guide body 113f according to the embodiment, the area of one slope face of each of the plurality of first prism bodies 21 is different from the area of the other slope face. Also in this case, the vertex angle of the plurality of first prism bodies 21 on the opposite side to the first major surface 10ma (the first vertex angle β1) is a right angle (e.g. not less than 80 degrees and not more than 110 degrees).

Thus, the first prism array unit 20 may be variously modified.

Similarly, also the second prism array unit 30 may be variously modified.

For example, the plurality of second prism bodies 31 may be away from one another. At this time, the high refractive index layer 32 or the low refractive index layer 33 may be further provided. The top of the plurality of third prism bodies 31 may be flat or in a curved surface form. The portion between the plurality of second prism bodies 31 (bottom) may be in a curved surface form. The area of one slope face of each of the plurality of second prism bodies 31 may be different from the area of the other slope face.

Also in such light guide bodies, the spread of the light that has entered can be suppressed.

In the embodiment, the pitch (the width along the Y-axis direction) of the first prism body 21 is substantially the same as the pitch (the width along the Y-axis direction) of the second prism body 31. However, the embodiment is not limited thereto, but the pitch of the first prism body 21 may be different from the pitch of the second prism body 31.

In the embodiment, the position in the Y-axis direction of the top of the first prism body 21 is substantially the same as the position in the Y-axis direction of the top of the second prism body 31. However, the embodiment is not limited thereto, but the position in the Y-axis direction of the top of the first prism body 21 may be substantially the same as the position in the Y-axis direction of the portion between the second prism bodies 31 (bottom). Furthermore, the relationship between the position in the Y-axis direction of the top of the first prism body 21 and the position in the Y-axis direction of the top of the second prism body 31 is arbitrary.

In the embodiment, the axis of the first prism body 21 and the axis of the second prism body 31 are parallel to each other (that is, parallel to the Z-axis direction). Therefore, the embodiment has the advantage that the formation of the first prism body 21 and the second prism body 31 is easy.

The light guide body according to the embodiment guides the light 51 toward the second side surface 10sb while controlling the width along the Y-axis direction of the light 51 that has entered through the first side surface 10sa. At this time, by extracting the light 51 in a direction along the X-axis direction, the light guide body can be utilized for a surface light source.

Configurations for extracting the light 51 in a direction along the X-axis direction will now be described.

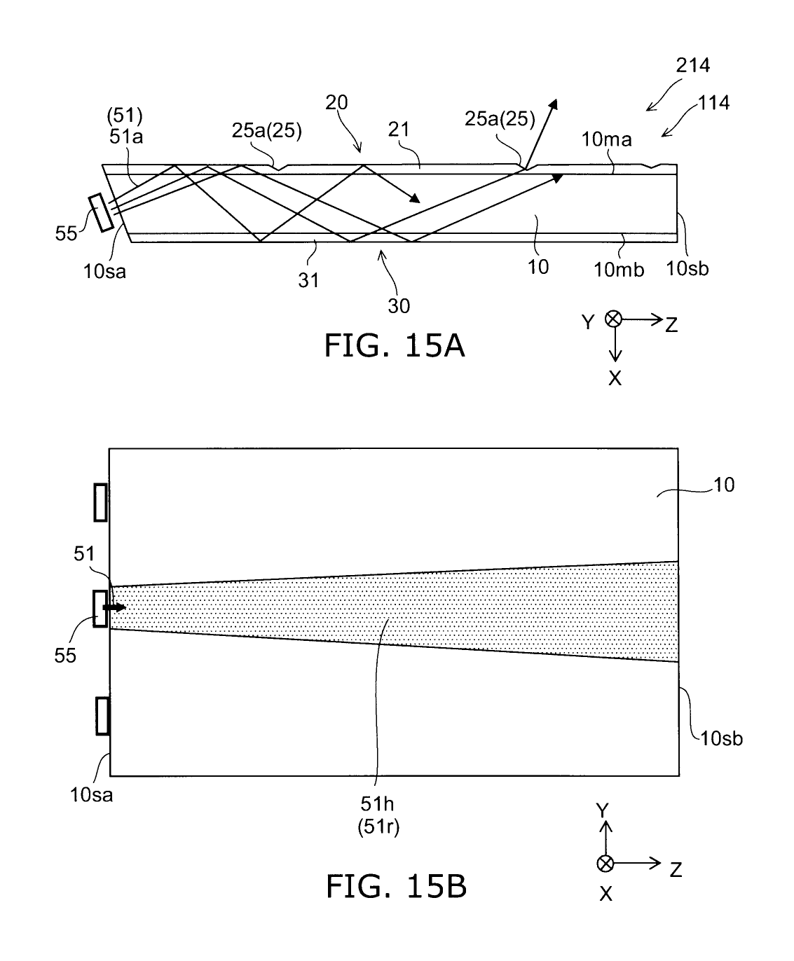

FIG. 15A and FIG. 15B are schematic cross-sectional views illustrating the configuration and operation of a light guide body and a surface light source according to the first embodiment.

As shown in FIG. 15A, in another light guide body 114 and another surface light source 214 according to the embodiment, the first prism array unit 20 includes a deflection unit 25. In this specific example, the deflection unit 25 is an unevenness 25a provided at at least part of the surfaces of the plurality of first prism bodies 21.

Part of the light 51 propagated in the first prism array unit 20 is incident on the unevenness 25a. The light 51 incident on the unevenness 25a is caused to change direction. For example, part of the light 51 caused to change direction does not experience total internal reflection at the surface of the first prism body 21. This light 51 is extracted to the exterior of the first prism array unit 20.

A notch formed at the surface of the first prism body 21 may be used as the unevenness 25a. The notch has an inclined surface with an angle from the Y-Z plane of approximately 20 degrees, for example. The notch is, for example, a V groove.

As shown in FIG. 15B, when the light 51 is entered through the first side surface 10sa of the light guide plate 10, band-like light extending along the Z-axis direction is emitted along the X-axis direction. That is, a region 51h where the intensity of the light emitted from the light guide plate 10 along the X-axis direction is high (i.e., the light guide region 51r) is in a band shape extending along the Z-axis direction. For example, in the case where the spread angle of the light 51 entering through the first side surface 10sa is +10 degrees, the angle of the spread in a direction along the Y-axis direction of the region 51h where the intensity of light is high is approximately ±5 degrees. Thus, the angle of the spread along the Y-axis direction of the band extending along the Z-axis direction of the light emitted from the light guide plate 10 along the X-axis direction is small. For example, the angle of the spread along the Y-axis direction of the band extending along the Z-axis direction of the light emitted from the light guide plate 10 along the X-axis direction is suppressed to not more than the spread angle of the light incident on the light guide plate 10.

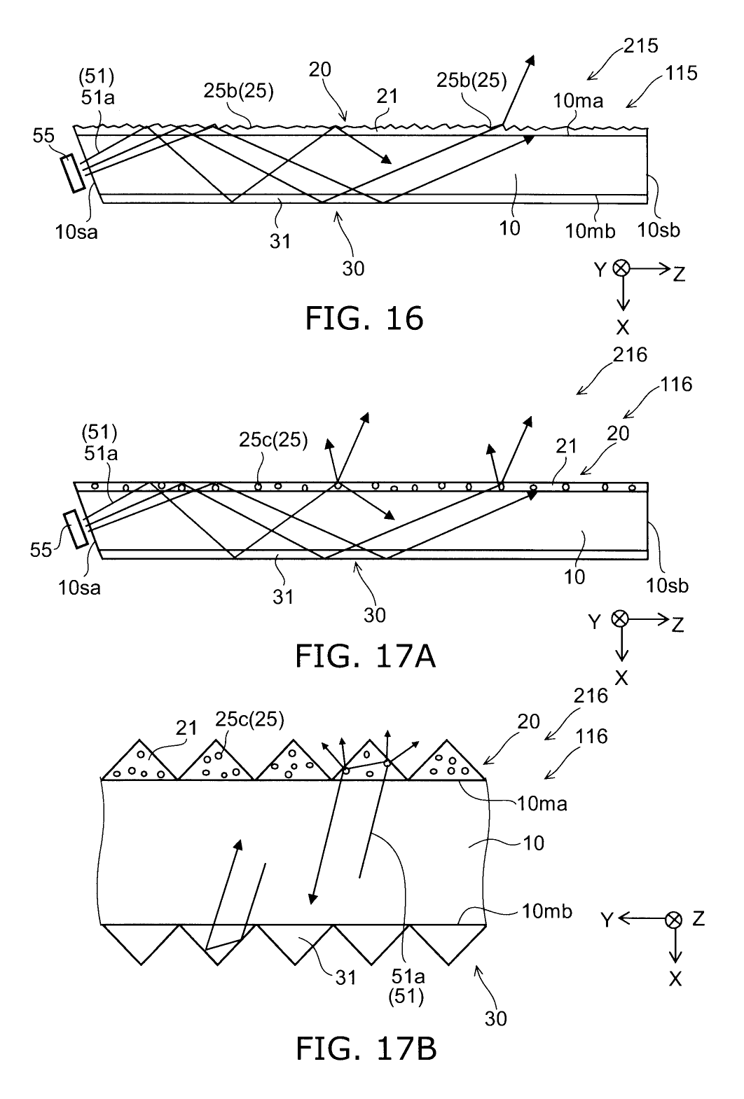

FIG. 16 is a schematic cross-sectional view illustrating the configuration and operation of a light guide body and a surface light source according to the first embodiment.

As shown in FIG. 16, in another light guide body 115 and another surface light source 215 according to the embodiment, the first prism array unit 20 includes the deflection unit 25. In this specific example, the deflection unit 25 is a rough surface portion 25b provided at at least part of the surfaces of the plurality of first prism bodies 21.

Part of the light 51 propagated in the first prism array unit 20 is incident on the rough surface portion 25b. The light 51 incident on the rough surface portion 25b is caused to change direction to be extracted to the exterior of the first prism array unit 20.

The rough surface portion 25b may be formed by, for example, processing the surface of the first prism body 21. This processing may be performed by an arbitrary method such as, for example, blasting the surface of the first prism body 21 with particles, machining the surface of the first prism body 21, and treating the surface of the first prism body 21 with a chemical liquid or the like. Furthermore, also a method may be used in which a portion that forms the rough surface portion 25b is provided in a mold or the like for molding the first prism body 21, and the first prism body 21 is fabricated using the mold or the like.

The rough surface portion 25b may be formed over the entire surface (slope face) of the first prism body 21. The rough surface portion 25b may be formed at part of the surface (slope face) of the first prism body 21.

FIG. 17A and FIG. 17B are schematic cross-sectional views illustrating the configuration and operation of a light guide body and a surface light source according to the first embodiment.

As shown in FIG. 17A and FIG. 17B, in another light guide body 116 and another surface light source 216 according to the embodiment, the first prism array unit 20 includes the deflection unit 25. In this specific example, the deflection unit 25 consists of scatterers 25c provided at at least part of the surfaces of the plurality of first prism bodies 21.

Part of the light 51 propagated in the first prism array unit 20 is incident on the scatterers 25c. The light 51 incident on the scatterers 25c is caused to change direction. In part of the light 51 caused to change direction, the conditions for total internal reflection are not satisfied at the slope face of the first prism body 21. This light is extracted to the exterior of the first prism array unit 20.

Particles with a diameter of one micrometer (μm) (e.g. not less than 0.5 μm and not more than 3 μm, etc.), for example, may be used for the scatterers 25c. The scatterers 25c may be formed by dispersing such particles in a resin that forms the first prism body 21 and using the resin in this state to form the first prism body 21. The refractive index of the scatterers 25c is different from the refractive index of the resin that forms the first prism body 21.

In the case where, for example, a material with a refractive index of 1.52 is used as a resin that forms the first prism body 21, silica (refractive index being 1.44), for example, may be used for the scatterers 25c.

The scatterers 25c may be uniformly dispersed in the first prism array unit 20. The concentration of the scatterers 25c may be non-uniform in the first prism array unit 20. The scatterers 25c may be locally dispersed in part of the first prism array unit 20. For example, the scatterers 25c may be selectively provided in the surface portion of the first prism array unit 20 (the first prism body 21).

Thus, the first prism array unit 20 may include the deflection unit 25. The deflection unit 25 includes at least one of the scatterers 25c provided in at least part of the first prism array unit 20, the unevenness 25a provided at at least part of the surfaces of the plurality of first prism bodies 21, and the rough surface portion 25b provided at at least part of the surfaces of the plurality of first prism bodies 21.

Such configurations make it possible to extract the light 51 propagated in the light guide body toward a direction along the X-axis direction. The angle of the spread along the Y-axis direction of the light guide region 51r of the light that becomes light emitted from the light guide plate 10 along the X-axis direction is small. For example, the angle of the spread along the Y-axis direction of the light guide region 51r of the light that becomes light emitted from the light guide plate 10 along the X-axis direction is not more than the spread angle of the light incident on the light guide plate 10.

In the embodiment, an arbitrary material may be used for the light guide plate 10. For example, any resin transparent to the light 51 and the like may be used for the light guide plate 10. For example, PMMA (poly(methyl methacrylate), refractive index=1.49) may be used for the light guide plate 10. Also a fluorine-based material, for example, may be used for the light guide plate 10.

The length in the Z-axis direction of the light guide plate 10 is, for example, not less than 0.03 meters (m) and not more than 2 m. The length in the Y-axis direction of the light guide plate 10 is, for example, not less than 0.03 m and not more than 2 m. The length in the X-axis direction (thickness) of the light guide plate 10 is, for example, not less than 1 millimeter (mm) and not more than 30 mm. However, the length in the Z-axis direction, the length in the Y-axis direction, and the length in the X-axis direction (thickness) of the light guide plate 10 are arbitrary.

An arbitrary material may be used for the first prism body 21 (the first prism array unit 20) and the second prism body 31 (the second prism array unit 30). Any resin transparent to the light 51 and the like, for example, may be used for the first prism body 21 and the second prism body 31. For example, in addition to PMMA and the like, a cyclic olefin resin and the like may be used for the first prism body 21 and the second prism body 31. ARTON (manufactured by JSR Corporation, refractive index: 1.52), for example, may be used for the first prism body 21 and the second prism body 31.

The width along the Y-axis direction (i.e., pitch) of the first prism body 21 and the second prism body 31 may be not less than 0.01 mm and not more than 5 mm. However, the width along the Y-axis direction of the first prism body 21 and the second prism body 31 is arbitrary. The first prism array unit 20 is provided on at least part of the first major surface 10ma of the light guide plate 10. The second prism array unit 30 is provided on at least part of the second major surface 10mb of the light guide plate 10.

A prism body formed by processing the surface of a sheet, for example, may be used as the first prism array unit 20 and the second prism array unit 30. By attaching such a sheet to the light guide plate 10, the light guide body can be formed. Any material transparent to the light 51 may be used as an adhesive used at this time. The adhesive may be regarded as the high refractive index layers 22 and 32 or the low refractive index layers 23 and 33. Photopolymer NOA65 (Norland Optical Adhesive 65, manufactured by Norland Products Inc., refractive index: 1.52), for example, may be used as the adhesive.

### Second Embodiment

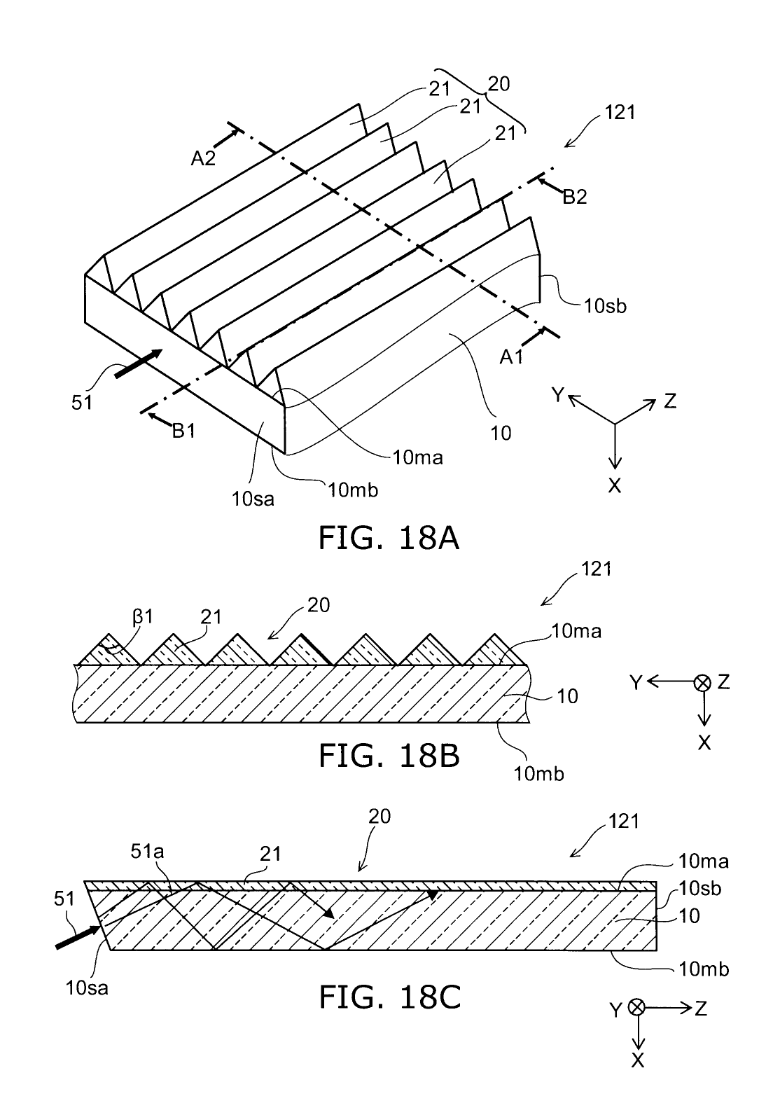

FIG. 18A to FIG. 18C are schematic views illustrating the configuration of a light guide body according to a second embodiment.

More specifically, FIG. 18A is a perspective view. FIG. 18B is a cross-sectional view taken along line A1-A2 of FIG. 18A. FIG. 18C is a cross-sectional view taken along line B1-B2 of FIG. 18A.

As shown in FIG. 18A to FIG. 18C, a light guide body 121 according to the embodiment includes the light guide plate 10 and the first prism array unit 20.

The light guide plate 10 has the first major surface 10ma, the second major surface 10mb, the first side surface 10sa, and the second side surface 10sb. The second major surface 10mb is the surface on the opposite side to the first major surface 10ma. The second side surface 10sb is the surface on the opposite side to the first side surface 10sa. Also in the embodiment, light 51 enters through the first side surface 10sa of the light guide plate 10.

The first prism array unit 20 is provided on the first major surface 10ma of the light guide plate 10 to be in contact with the first major surface 10ma. The first prism array unit 20 includes the plurality of first prism bodies 21. Each of the plurality of first prism bodies 21 extends along the Z-axis direction. The plurality of first prism bodies 21 are disposed to align along the Y-axis direction. The vertex angle of the plurality of first prism bodies 21 on the opposite side to the first major surface 10ma (the first vertex angle β1) is a right angle.

The refractive index of the plurality of first prism bodies 21 is higher than the refractive index of the light guide plate 10.

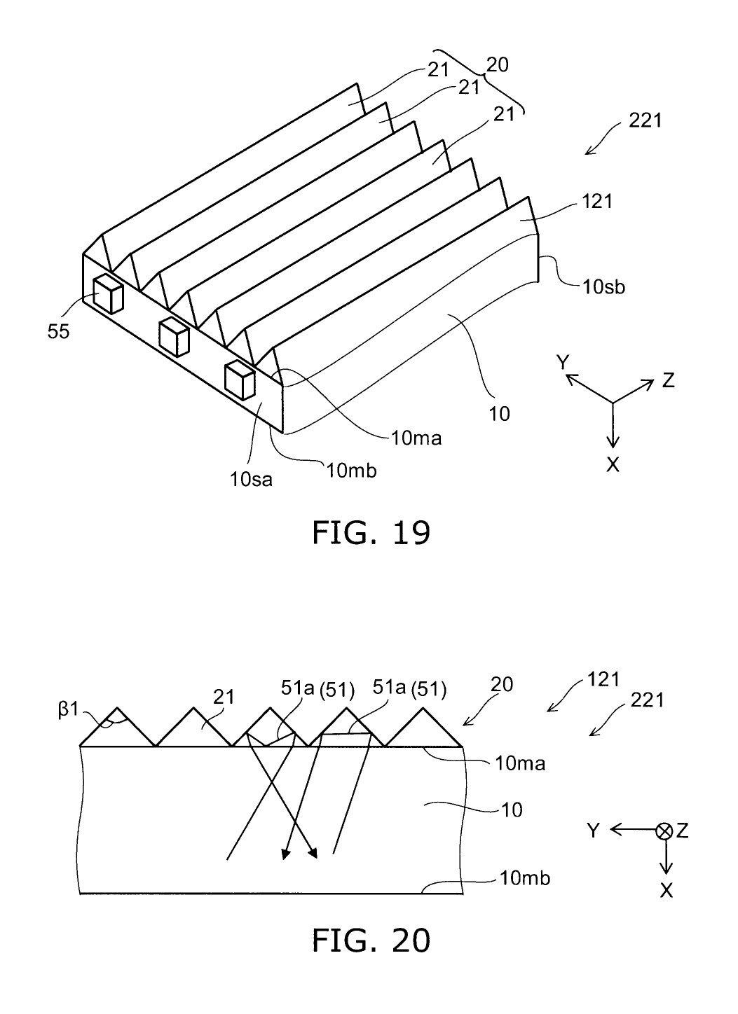

FIG. 19 is a schematic view illustrating the configuration of a surface light source according to the second embodiment.

As shown in FIG. 19, a surface light source 221 according to the embodiment includes the light guide body 121 and the light sources 55. The light sources 55 are facing the first side surface 10sa of the light guide plate 10. The light source 55 enters light 51 into the light guide plate 10 through the first side surface 10sa.

The light guide body 121 and the surface light source 221 having such configurations can provide a light guide body and a surface light source excellent in the controllability of the spread of the light that has entered.

FIG. 20 is a schematic view illustrating the operation of the light guide body and the surface light source according to the second embodiment.

As shown in FIG. 20, the light 51 is reflected at a slope face of the first prism body 21. The light 51 is retroreflected by total internal reflection, for example. Then, part of the light 51 reflected at the first prism body 21 is totally reflected at the interface between the first prism body 21 (the first prism array unit 20) and the light guide plate 10, and totally reflected at another slope face of the first prism body 21 to return to the light guide plate 10. As a result, also in the case of light 51 having a large component in the Y-axis direction, the spread along the Y-axis direction of the light 51 can be sufficiently suppressed.

That is, in the light guide body 121 and the surface light source 221 according to the embodiment, the second prism array unit 30 is not provided. Hence, the function of narrowing the width of the light 51 along the Y-axis direction is not provided at the second major surface 10mb of the light guide plate 10. In view of this, in this configuration, the refractive index of the plurality of first prism bodies 21 is set higher than the refractive index of the light guide plate 10. Thereby, also in the configuration in which the prism body is provided only on the first major surface 10ma side, the width along the Y-axis direction of the light 51 can be sufficiently narrowed in a practical viewpoint. The embodiment can improve the controllability of the spread of the light that has entered.

As a reference example, a configuration may be possible in which the extending direction of the first prism body is set to the Y-axis direction and the refractive index of the first prism body is higher than the refractive index of the light guide plate 10. In other words, this is a configuration in which the third prism array unit 39 is omitted and the refractive index of the first prism body 29a is set higher than the refractive index of the light guide plate 10 in the light guide body 119a and the surface light source 219a of the reference example illustrated in FIG. 7A. In this configuration, since the first prism body 29a extends along the Y-axis direction, it is difficult to narrow the width along the Y-axis direction of the light 51. That is, in the case of the reference example, the width of the light 51 propagated in the Z-axis direction is widened along the Y-axis direction. In the case of the configuration of the reference example, the intensity of the light 51 is made uniform along the Y-axis direction.

In the light guide body and the surface light source according to the embodiment, since the second prism array unit 30 is omitted, the cost can be reduced as compared to the first embodiment.

In the embodiment, the configuration and material described in regard to the light guide plate 10 and the first prism array unit 20 in the first embodiment may be used as the configuration and material of the light guide plate 10 and the first prism array unit 20.

For example, similarly to those described in regard to FIG. 11A to FIG. 11E, the direction of the optical axis 51ax of the light 51 when the light 51 is incident on the first side surface 10sa is inclined with respect to the X-axis direction. Furthermore, the angle θ1 between the direction of the optical axis 51ax and the Z-axis direction is larger than the spread angle θ2 of light when the light 51 is incident on the first side surface 10sa. The light 51 entering through the first side surface 10sa has a component in a direction inclined with respect to the X-axis direction.

The direction of the optical axis 51ax of the light 51 when the light 51 is incident on the first side surface 10sa may be parallel to the Z-axis direction. Preferably the direction of the optical axis 51ax has substantially no component in the Y-axis direction and has a component in the X-axis direction.

The first side surface 10sa may include an inclined surface inclined with respect to both the Z-axis direction and the X-axis direction. The first side surface 10sa may include a recess (groove) extending along the Y-axis direction. The first side surface 10sa may include a protrusion extending along the Y-axis direction.

Thus, also in the embodiment, the first side surface 10sa may include an inclined surface inclined with respect to the Z-axis direction. The inclined surface is, for example, parallel to the Y-axis direction.

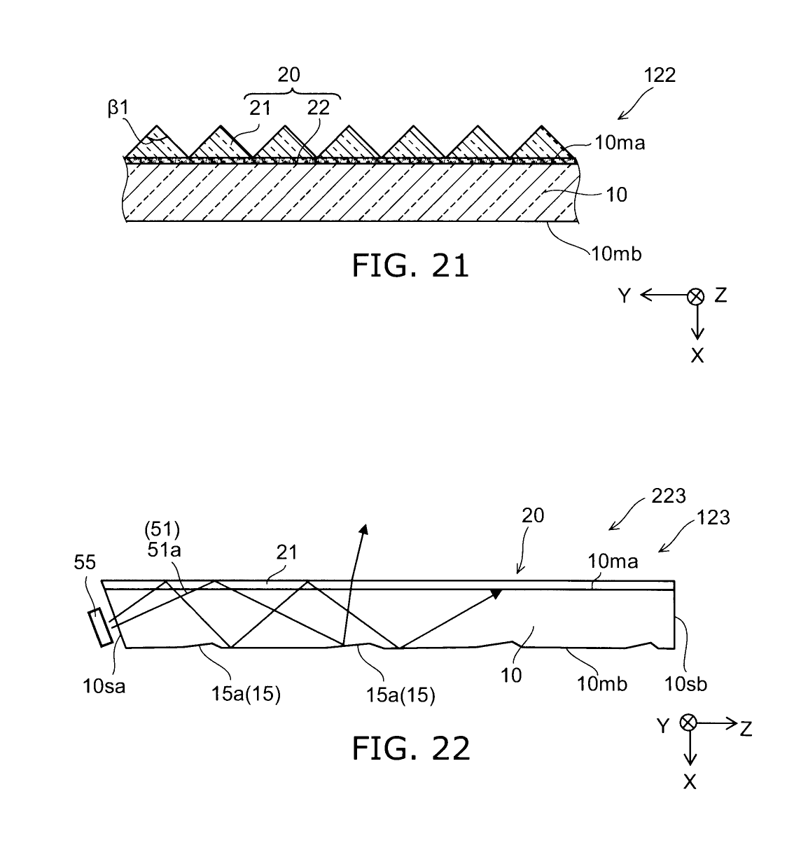

FIG. 21 is a schematic cross-sectional view illustrating the configuration of a light guide body according to the second embodiment.

As shown in FIG. 21, in another light guide body 122 according to the embodiment, the first prism array unit 20 further includes the high refractive index layer 22. The high refractive index layer 22 is provided between the light guide plate 10 and the plurality of first prism bodies 21. The high refractive index layer 22 has a refractive index higher than the refractive index of the light guide plate 10. For example, the refractive index of the high refractive index layer 22 is the same as the refractive index of the plurality of first prism bodies 21. The same material as the material used for the first prism body 21, for example, is used for the high refractive index layer 22. The configuration makes it easy to improve productivity.

In the light guide body according to the embodiment, light can be extracted through the second major surface 10mb side. The light guide plate 10 is provided with, for example, a deflection unit for extracting the light 51 in a direction along the X-axis direction.

FIG. 22 is a schematic cross-sectional view illustrating the configuration and operation of a light guide body and a surface light source according to the second embodiment.

As shown in FIG. 22, in another light guide body 123 and another surface light source 223 according to the embodiment, the light guide plate 10 includes a deflection unit 15. In the specific example, the deflection unit 15 is an unevenness 15a provided at at least one of the first major surface 10ma and the second major surface 10mb of the light guide plate 10. In the specific example, the unevenness 15a is provided at the second major surface 10mb.

Part of the light 51 is incident on the unevenness 15a. The light 51 incident on the unevenness 15a is caused to change direction, and part of the light 51 is extracted to the exterior of the light guide plate 10.

A notch formed at the second major surface 10mb of the light guide plate 10 may be used as the unevenness 15a. The notch has, for example, an inclined surface with an angle from the Y-Z plane of approximately 20 degrees. The notch is, for example, a V groove.

The embodiment can reduce the angle of the spread along the Y-axis direction of the light guide region 51r of the light that becomes light emitted from the light guide plate 10 along the X-axis direction.

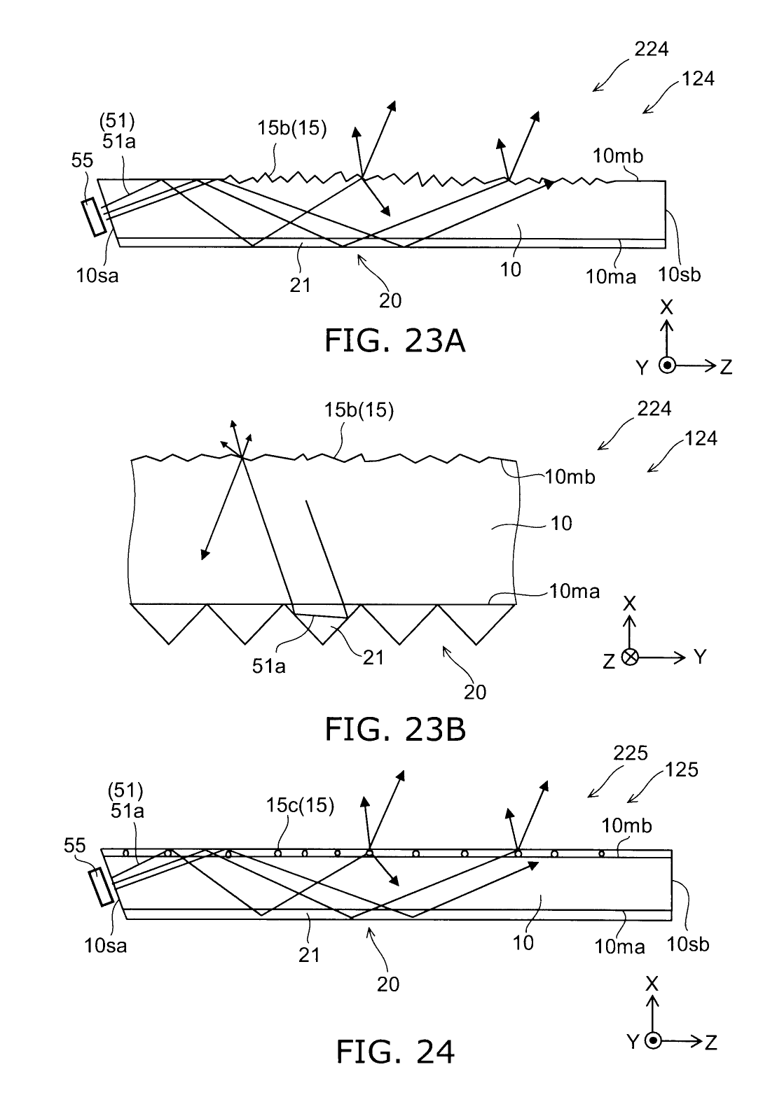

FIG. 23A and FIG. 23B are schematic cross-sectional views illustrating the configuration and operation of a light guide body and a surface light source according to the second embodiment.

As shown in FIG. 23A and FIG. 23B, in another light guide body 124 and another surface light source 224 according to the embodiment, the light guide plate 10 includes the deflection unit 15. In the specific example, the deflection unit 15 is a rough surface portion 15b provided at at least one of the first major surface 10ma and the second major surface 10mb of the light guide plate 10. In the specific example, the rough surface portion 15b is provided at the second major surface 10mb.

Part of the light 51 is incident on the rough surface portion 15b. The light 51 incident on the rough surface portion 15b is caused to change direction, and part of the light 51 is extracted to the exterior of the light guide plate 10.

The rough surface portion 15b may be formed by an arbitrary method such as surface processing by blasting the surface with particles, surface processing by machining, and surface treatment with a chemical liquid. Also a method may be used in which a portion that forms the rough surface portion 15b is provided in a mold or the like used during molding the light guide plate 10, and the light guide plate 10 is fabricated using the mold or the like.

The rough surface portion 15b may be formed over the entire surface (the second major surface 10mb) of the light guide plate 10. The rough surface portion 15b may be formed at part of the surface (the second major surface 10mb) of the light guide plate 10.

FIG. 24 is a schematic cross-sectional view illustrating the configuration and operation of a light guide body and a surface light source according to the second embodiment.

As shown in FIG. 24, in another light guide body 125 and another surface light source 225 according to the embodiment, the light guide plate 10 includes the deflection unit 15. In the specific example, the deflection unit 15 consists of scatterers 15c provided in at least part of the light guide plate 10.

Part of the light 51 is incident on the scatterers 15c. The light incident on the scatterers 15c is caused to change direction, and part of the light 15 is extracted to the exterior of the light guide plate 10.

Particles with diameters of not less than 0.5 μm and not more than 3 μm, for example, may be used for the scatterers 15c. The scatterers 15c may be formed by dispersing such particles in a resin that forms the light guide plate 10 and using the resin in this state to form the light guide plate 10. The refractive index of the scatterers 15c is different from the refractive index of the resin used for the light guide plate 10. Silica, for example, may be used for the scatterers 15c.

The scatterers 15c may be uniformly dispersed in the light guide plate 10. The concentration of the scatterers 15c may be non-uniform in the light guide plate 10. The scatterers 15c may be locally dispersed in part of the light guide plate 10. For example, the scatterers 15c may be selectively provided in a portion on the surface (the second major surface 10mb) side of the light guide plate 10.

Thus, in the embodiment, the light guide plate 10 may include the deflection unit 15. The deflection unit 15 includes at least one of the scatterers 15c provided in at least part of the light guide plate 10, the unevenness 15a provided at at least one of the first major surface 10ma and the second major surface 10mb of the light guide plate 10, and the rough surface portion 15b provided at at least one of the first major surface 10ma and the second major surface 10mb of the light guide plate 10.

### Third Embodiment

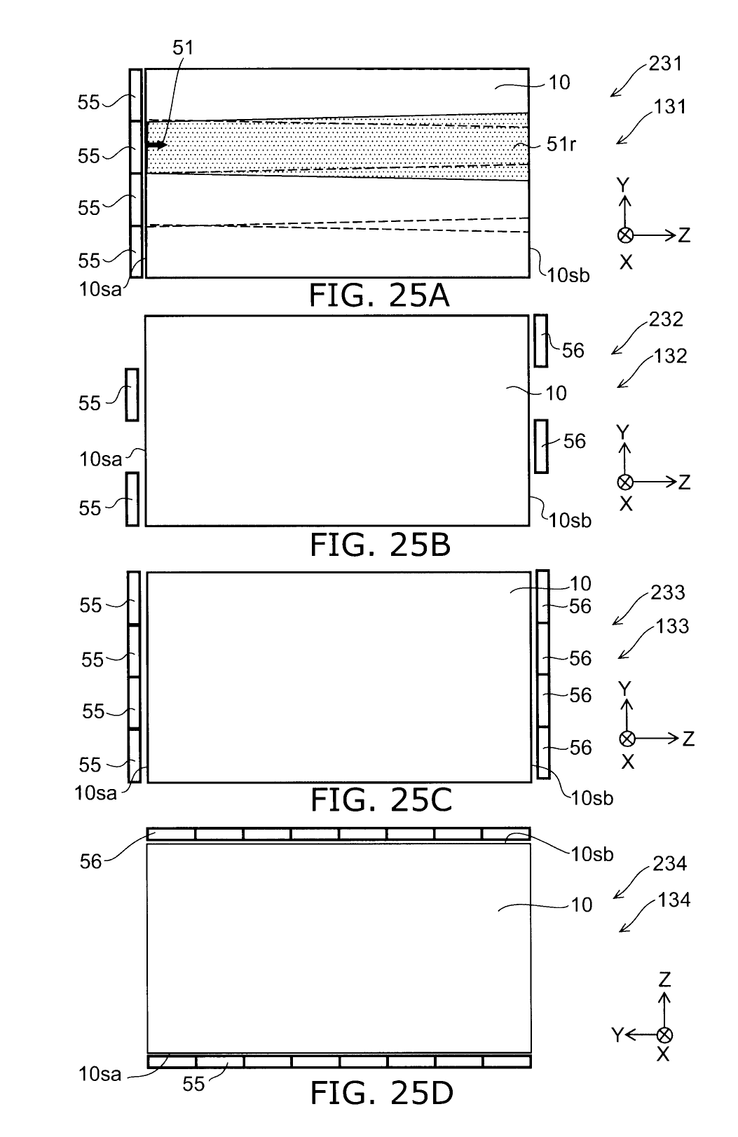

FIG. 25A to FIG. 25D are schematic views illustrating the configurations of light guide bodies and surface light sources according to a third embodiment.

In the drawings, the first prism array unit 20 and the second prism array unit 30 are omitted and the light guide plate 10 and the light source 55 are drawn.

One of the light guide bodies and one of the surface light sources described in regard to the first embodiment and the second embodiment are used as the light guide body and the surface light source according to the embodiment. At least one of the deflection unit 15 and the deflection unit 25 described in regard to the first embodiment and the second embodiment is provided.

As shown in FIG. 25A, in a light guide body 131 and a surface light source 231 according to the embodiment, the light source 55 is provided plurally. That is, in the embodiment, a plurality of light sources 55 are provided on the first side surface 10sa.

The positional relationships among the plurality of light sources 55 are appropriately adjusted. In the specific example, the light guide regions 51r of the lights 51 emitted from the plurality of light sources 55 overlap with one another. Thereby, a surface light source with a uniform in-plane brightness can be obtained.

As shown in FIG. 25B, in a light guide body 132 and a surface light source 232 according to the embodiment, light sources 55 are provided on the first side surface 10sa and light sources 56 are provided on the second side surface 10sb. That is, the surface light source 232 further includes another light source (the light source 56) that is facing the second side surface 10sb of the light guide plate 10 and enters light into the light guide plate 10 through the second side surface 10sb.

In the specific example, a plurality of light sources 55 are provided on the first side surface 10sa and a plurality of light sources 56 are provided on the second side surface 10sb. The light source 55 provided on the first side surface 10sa and the light source 56 provided on the second side surface 10sb are not facing each other along the Z-axis direction.

Also in this case, the positional relationships among the plurality of light sources 55 and the plurality of light sources 56 are appropriately adjusted. For example, they are disposed so that the light guide regions 51r of the lights 51 emitted from the plurality of light sources 55 and the plurality of light sources 56 may overlap with one another. Thereby, a surface light source with a uniform in-plane brightness can be obtained.

As shown in FIG. 25C, in a light guide body 133 and a surface light source 233 according to the embodiment, the light source 55 provided on the first side surface 10sa and the light source 56 provided on the second side surface 10sb are facing each other along the Z-axis direction.

Depending on the design of the deflection unit (the deflection unit 15 and the deflection unit 25), for example, until light reaches the center in the Z-axis direction of the light guide body, a large part of the light may be emitted to the exterior of the light guide body. In this case, by providing the light source 55 and the light source 56 on the first side surface 10sa and the second side surface 10sb, respectively, the brightness can be made uniform in the whole (the whole along the Z-axis direction) of the light guide body.

Furthermore, crosstalk between adjacent light guide regions 51r is suppressed. Thereby, the light guide region 51r can be controlled in a smaller region with high accuracy. By adjusting the quantity of light of each light source, it becomes easier to adjust the in-plane brightness distribution of the surface light source in a small region with high accuracy.

As shown in FIG. 25D, in a light guide body 134 and a surface light source 234 according to the embodiment, the first side surface 10sa and the second side surface 10sb are side surfaces with great lengths out of the side surfaces of the light guide body 10. In the specific example, a plurality of light sources 55 are provided on the first side surface 10sa and a plurality of light sources 56 are provided on the second side surface 10sb. The light source 55 provided on the first side surface 10sa and the light source 56 provided on the second side surface 10sb are facing each other along the Z-axis direction.

Thus, the light source 55 (and the light source 56) may be provided plurally, and the arrangement of the light sources 55 (and the light sources 56) is arbitrary.

In the surface light source in which a plurality of light sources 55 are provided, the intensity of the lights incident on the light guide plate 10 from the plurality of light sources 55 may be independently controlled. That is, a plane parallel to the first major surface 10ma of the light guide plate 10 may include a first region with a high intensity of light and a second region with a lower intensity of light than the first region. In display devices and the like in which a surface light source is used, the first region and the second region may be controlled based on the display image. Thereby, the contrast of the display device is improved. Furthermore, the power consumption can be reduced.

That is, in the surface light source according to the embodiment, the distribution along the Y-axis direction of the brightness of the light emitted in a direction perpendicular to the first major surface 10ma can be altered.

### Fourth Embodiment

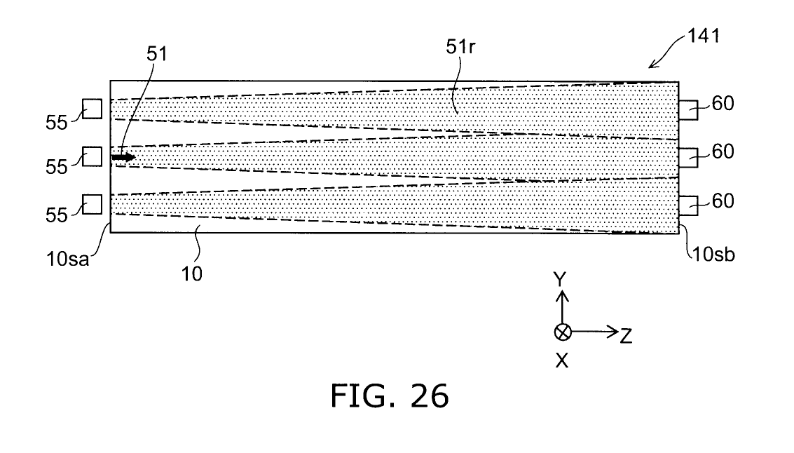

FIG. 26 is a schematic view illustrating the configuration of a light guide body according to a fourth embodiment.

As shown in FIG. 26, in a light guide body 141 according to the embodiment, light 51 enters the light guide plate 10 from the light source 55 through the first side surface 10sa. Light receiving units 60 that receive the light emitted through the second side surface 10sb are provided opposite to the second side surface 10sb. The light receiving unit 60 converts the signal included in the light emitted through the second side surface 10sb into, for example, an electric signal. An LED, for example, is used for the light source 55. A photodiode, for example, is used for the light receiving unit 60.

Any one of the light guide bodies described in regard to the first embodiment and the second embodiment may be used as the light guide body 141. In FIG. 26, the first prism array unit 20 (and the second prism array unit 30) is omitted.

The light source 55 is provided plurally and the light receiving unit 60 is provided plurally, for example. The position along the Y-axis direction of the light source 55 substantially coincides with the position along the Y-axis direction of the light receiving unit 60.

In the light guide body 141 according to the embodiment, the spread along the Y-axis direction of the light 51 that has entered through the first side surface 10sa is suppressed. Therefore, the light 51 emitted from one of the plurality of light sources 55 is incident on the light receiving unit 60 facing this light source 55 in the Z-axis direction, and is not substantially incident on the other light receiving units 60. Even in the case where light 51 is incident on another light receiving unit 60, the intensity of the light 51 is significantly low. Consequently, the signal (e.g. digital signal) included in the light emitted from a prescribed light source 55 is substantially received only by a prescribed light receiving unit 60.

The signals included in the lights emitted simultaneously from the plurality of light sources 55 are independently received by the respective plurality of light receiving units 60 corresponding to the plurality of light sources 55. That is, a plurality of signals can be transmitted and received in parallel.

In the embodiment, a light guide body of one kind of design specification can be used for cases where the number of first light sources 55 and the pitch of the light source 55 are different.

The light guide body in the embodiment may have flexibility. Thereby, the arrangement of transmission paths can have flexibility. For example, by appropriately setting the thickness, material, etc. of the light guide plate 10 and the prism array unit, the light guide body is provided with flexibility. For example, by setting the thickness of the light guide body not more than 1 mm, flexibility can be obtained.

The embodiment provides a light guide body and a surface light source excellent in the controllability of the spread of the light that has entered.

In the specification of the application, “perpendicular” and “parallel” refer to not only strictly perpendicular and strictly parallel but also include, for example, the fluctuation due to manufacturing processes, etc. It is sufficient to be substantially perpendicular and substantially parallel.

Hereinabove, embodiments of the invention are described with reference to specific examples. However, the embodiment of the invention is not limited to these specific examples. For example, one skilled in the art may appropriately select specific configurations of components of light guide bodies such as light guide plates, prism array units, prism bodies, high refractive index layers, low refractive index layers, and deflection units and components of surface light sources such as light sources from known art and similarly practice the invention. Such practice is included in the scope of the invention to the extent that similar effects thereto are obtained.

Further, any two or more components of the specific examples may be combined within the extent of technical feasibility and are included in the scope of the invention to the extent that the purport of the invention is included.

Moreover, all light guide bodies and surface light sources practicable by an appropriate design modification by one skilled in the art based on the light guide bodies and the surface light sources described above as embodiments of the invention also are within the scope of the invention to the extent that the spirit of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A light guide body comprising:
a light guide plate having a first major surface, a first side surface, and a second side surface on an opposite side to the first side surface; and
a first prism array unit provided on the first major surface of the light guide plate to be in contact with the first major surface,
the first prism array unit including a plurality of first prism bodies,
each of the plurality of first prism bodies extending along a first direction from the first side surface to the second side surface,
the plurality of first prism bodies being disposed to align along a second direction parallel to the first major surface and perpendicular to the first direction,
a vertex angle of the plurality of first prism bodies on an opposite side to the first major surface being a substantially right angle, and
a refractive index of the plurality of first prism bodies being higher than a refractive index of the light guide plate.

2. The body according to claim 1, wherein the first prism array unit further includes a high refractive index layer, the high refractive index layer being provided between the light guide plate and the plurality of first prism bodies and having a refractive index higher than the refractive index of the light guide plate.

3. The body according to claim 2, wherein the refractive index of the high refractive index layer is the same as the refractive index of the plurality of first prism bodies.

4. The body according to claim 1, wherein a direction of an optical axis of a light entered into the light guide plate through the first side surface when the light is incident on the first side surface is inclined with respect to a third direction perpendicular to both the first direction and the second direction.

5. The body according to claim 4, wherein an angle between the direction of the optical axis and the first direction is larger than a spread angle of the light when the light is incident on the first side surface.

6. The body according to claim 1, wherein the light guide plate includes a deflection unit including at least one of
a scatterer provided in at least a part of the light guide plate,
an unevenness provided at at least one of the first major surface of the light guide plate and a second major surface on an opposite side to the first major surface of the light guide plate, and
a rough surface portion provided at at least one of the first major surface and the second major surface of the light guide plate.

7. The body according to claim 1, wherein the first prism array unit includes a deflection unit including at least one of
a scatterer provided in at least a part of the first prism array unit,
an unevenness provided at at least a part of surfaces of the plurality of first prism bodies, and
a rough surface portion provided at at least a part of the surfaces of the plurality of first prism bodies.

8. The body according to claim 1, wherein the first side surface includes an inclined surface inclined with respect to both the first direction and a third direction perpendicular to both the first direction and the second direction.

9. The body according to claim 1, wherein the first side surface includes a recess or a protrusion extending along the second direction.

10. A light guide body comprising:
a light guide plate having a first major surface, a second major surface on an opposite side to the first major surface, a first side surface, and a second side surface on an opposite side to the first side surface;
a first prism array unit provided on the first major surface of the light guide plate to be in contact with the first major surface; and
a second prism array unit provided on the second major surface of the light guide plate to be in contact with the second major surface,
the first prism array unit including a plurality of first prism bodies,
each of the plurality of first prism bodies extending along a first direction from the first side surface to the second side surface,
the plurality of first prism bodies being disposed to align along a second direction parallel to the first major surface and perpendicular to the first direction,
a vertex angle of the plurality of first prism bodies on an opposite side to the first major surface being a substantially right angle,
the second prism array unit including a plurality of second prism bodies,
each of the plurality of second prism bodies extending along the first direction,
the plurality of second prism bodies being disposed to align along the second direction, and
a vertex angle of the plurality of second prism bodies on an opposite side to the second major surface being a substantially right angle.

11. The body according to claim 10, wherein at least one of a refractive index of the plurality of first prism bodies and a refractive index of the plurality of second prism bodies is higher than a refractive index of the light guide plate.

12. The body according to claim 10, wherein the first prism array unit further includes a high refractive index layer provided between the light guide plate and the plurality of first prism bodies and having a refractive index higher than the refractive index of the light guide plate.

13. The body according to claim 12, wherein the refractive index of the high refractive index layer is the same as the refractive index of the plurality of first prism bodies.

14. The body according to claim 10, wherein a direction of an optical axis of light entered into the light guide plate through the first side surface when the light is incident on the first side surface is inclined with respect to a third direction perpendicular to both the first direction and the second direction.

15. The body according to claim 14, wherein an angle between the direction of the optical axis and the first direction is larger than a spread angle of the light when the light is incident on the first side surface.

16. The body according to claim 10, wherein the light guide plate includes a deflection unit including at least one of
a scatterer provided in at least a part of the light guide plate,
an unevenness provided at at least one of the first major surface of the light guide plate and a second major surface on an opposite side to the first major surface of the light guide plate, and
a rough surface portion provided at at least one of the first major surface and the second major surface of the light guide plate.

17. The body according to claim 10, wherein the first prism array unit includes a deflection unit including at least one of
a scatterer provided in at least a part of the first prism array unit,
an unevenness provided at at least a part of surfaces of the plurality of first prism bodies, and
a rough surface portion provided at at least a part of the surfaces of the plurality of first prism bodies.

18. The body according to claim 10, wherein the first side surface includes an inclined surface inclined with respect to both the first direction and a third direction perpendicular to both the first direction and the second direction.

19. The body according to claim 10, wherein the first side surface includes a recess or a protrusion extending along the second direction.

20. A surface light source comprising:
a light guide body including:
a light guide plate having a first major surface, a first side surface, and a second side surface on an opposite side to the first side surface; and
a first prism array unit provided on the first major surface of the light guide plate to be in contact with the first major surface,
the first prism array unit including a plurality of first prism bodies,
each of the plurality of first prism bodies extending along a first direction from the first side surface to the second side surface,
the plurality of first prism bodies being disposed to align along a second direction parallel to the first major surface and perpendicular to the first direction,
a vertex angle of the plurality of first prism bodies on an opposite side to the first major surface being a substantially right angle, and
a refractive index of the plurality of first prism bodies being higher than a refractive index of the light guide plate; and
a light source facing the first side surface of the light guide plate, and configured to enter light into the light guide plate through the first side surface.
